(19) United States
(12) Patent Application Publication
(10) Pub. No.: US 2026/0250900 A1
(43) Pub. Date: Aug. 27, 2026

(54) DRYING MODULE AND WASHER-DRYER MACHINE

(71) Applicant: Nanjing Roborock Innovation Technology Co., Ltd., Nanjing (CN)

(72) Inventors: Xing Li, Shenzhen (CN); Chuanlin Duan, Shenzhen (CN); Zhimin Yang, Shenzhen (CN); Zhe Wang, Shenzhen (CN); Tong Liu, Shenzhen (CN); Hang Qi, Shenzhen (CN); Gang Quan, Shenzhen (CN)

(21) Appl. No.: 19/107,976

(22) PCT Filed: Aug. 30, 2023
(86) PCT No.: PCT/CN2023/115747

§ 371 Date: Feb. 28, 2025

(30) Foreign Application Priority Data
Aug. 31, 2022 (CN) 202222305009.6
Aug. 31, 2022 (CN) 202222307052.6
Aug. 31, 2022 (CN) 202222307069.1
Aug. 31, 2022 (CN) 202222307661.1
Aug. 31, 2022 (CN) 202222314788.6
Aug. 31, 2022 (CN) 202222316065.X
Aug. 31, 2022 (CN) 202222322147.5

(51) Int. Cl. D06F 58/26; D06F 58/24

(52) U.S. Cl. CPC D06F 58/26; D06F 58/24

(57) ABSTRACT

A drying module includes: a circulator, communicated with an accommodating apparatus and configured to output a wet airflow from the accommodating apparatus to a dehumidifier; the dehumidifier, communicated with the circulator and the accommodating apparatus, and configured to adsorb moisture of the wet airflow from the accommodating apparatus; a regenerator, communicated with at least a portion of the dehumidifier, and configured to output a regeneration airflow to the dehumidifier, so as to desorb moisture adsorbed by the dehumidifier; and a shell, provided with accommodating areas for respectively accommodating the circulator, the dehumidifier and the regenerator.

### CROSS-REFERENCE TO RELATED APPLICATIONS

The present application claims the priority of the Chinese patent application No. 202222314788.6, filed with the China Patent Office on Aug. 31, 2022 and entitled “Drying module and washer-dryer machine”; the entire contents of which are incorporated by reference in the present application.

The present application claims the priority of the Chinese patent application No. 202222307052.6, filed with the China Patent Office on Aug. 31, 2022 and entitled “Circulation module, drying apparatus and washer-dryer machine”, the entire contents of which are incorporated by reference in the present application.

The present application claims the priority of the Chinese patent application No. 202222305009.6, filed with the China Patent Office on Aug. 31, 2022 and entitled “Drying module and washer-dryer machine”, the entire contents of which are incorporated by reference in the present application.

The present application claims the priority of the Chinese patent application No. 202222322147.5, filed with the China Patent Office on Aug. 31, 2022 and entitled “Drying module and washer-dryer machine”, the entire contents of which are incorporated by reference in the present application.

The present application claims the priority of the Chinese patent application No. 202222307661.1, filed with the China Patent Office on Aug. 31, 2022 and entitled “Drying module and washer-dryer machine”, the entire contents of which are incorporated by reference in the present application.

The present application claims the priority of the Chinese patent application No. 202222307069.1, filed with the China Patent Office on Aug. 31, 2022 and entitled “Drying module and washer-dryer machine”, the entire contents of which are incorporated by reference in the present application.

The present application claims the priority of the Chinese patent application No. 202222316065.X, filed with the Chinese Patent Office on Aug. 31, 2022 and entitled “Pipeline connection module for drying module”, the entire contents of which are incorporated by reference in the present application.

### TECHNICAL FIELD

Embodiments of the present application relate to the field of electrical appliance technology, and in particular to a drying module and a washer-dryer machine.

### BACKGROUND OF THE INVENTION

Driven by factors such as people's increasing pursuit of healthy and quality life and the accelerating pace of life of urban residents, washer-dryer machines have emerged and are deeply loved by consumers. Washer-dryer machines are especially suitable for southern families during a rainy season, northern families where an air quality is poor and is not suitable for outdoor drying of clothes, and people who want to wear clothes immediately after washing or pursue more fluffy and comfortable clothes.

The inventors have discovered that a drying system of the existing washer-dryer machine utilizes an evaporator to heat and adsorb moisture from a humid air in an inner drum of the washer-dryer machine to obtain high-temperature air which re-enters the inner drum of the washer-dryer machine, thereby evaporating the moisture in the clothes, However, the overall temperature of the evaporator is consistent, and during the evaporation of the humid air, the evaporator's ability to adsorb moisture from the humid air decreases, resulting in low moisture adsorption efficiency, long drying time, and high power consumption. There are also some existing washer-dryer machines that utilize condensate water spraying or a condenser to direct dehumidify a wet airflow, wherein the treated airflow still carries a high proportion of moisture, and the circulation utilization also requires a process of heating, cooling and dehumidifying, and reheating the airflow, which has a low dehumidification efficiency and high power consumption.

### SUMMARY OF THE INVENTION

The purpose of the present application is to provide a drying module and a washer-dryer machine to solve the problem in the prior art that the dehumidified airflow still carries a high proportion of moisture, and the circulation utilization also requires the process of heating, cooling and dehumidifying, and reheating the airflow, resulting in low dehumidification efficiency and high power consumption.

To solve the above technical problems, according to some embodiments, the present application provides a drying module, including:
a circulation module, communicated with a drum and configured to output a wet airflow from the drum to a dehumidification module;
the dehumidification module, communicated with the circulation module and the drum, and configured to adsorb moisture of the wet airflow from the drum;
a regeneration module, communicated with at least a portion of the dehumidification module, and configured to output a regeneration airflow to the dehumidification module, so as to desorb moisture adsorbed by the dehumidification module; and
a shell, provided with accommodating areas for respectively accommodating the circulation module, the dehumidification module and the regeneration module.

The present application further provides a washer-dryer machine, including the drying module according to any one of the above technical solutions.

In addition, the washer-dryer machine further includes:
the drum, provided with a drum air inlet and a drum air outlet respectively arranged at two opposite ends of the drum,
wherein a second airflow channel or a first airflow channel is communicated with the drum air outlet, and the first airflow channel or the second airflow channel is communicated with the drum air inlet, and
a wet circulation airflow in the drum passes through the second airflow channel or the first airflow channel, and passes through a rotary disk to reach the first airflow channel or the second airflow channel to form a dry airflow, the rotary disk being configured to adsorb moisture in the wet circulation airflow.

### BRIEF DESCRIPTION OF DRAWINGS

Various other advantages and benefits will become apparent to those of ordinary skill in the art by reading the detailed description of the preferred implementations below. The accompanying drawings are only for the purpose of illustrating the preferred implementations and are not to be considered as limiting the present application. Also, the same reference numerals are used throughout the accompanying drawings to represent the same components. In the accompanying drawings:

FIG. 1 is a schematic structural diagram of a drying module according to a first implementation of the present application;

FIG. 2 is an exploded decomposition diagram of FIG. 1;

FIG. 3 is a schematic structural diagram of a lower shell according to a second implementation of the present application;

FIG. 4 is a schematic structural diagram of a lower shell according to a third implementation of the present application;

FIG. 5 is a schematic structural diagram of a rotary disk upper shell according to a fourth implementation of the present application;

FIG. 6 is a schematic structural diagram of a rotary disk upper shell according to a fifth implementation of the present application;

FIG. 7 is a schematic decomposition diagram of a partial structure of a drying module according to a sixth implementation of the present application;

FIG. 8 is a schematic exploded structural diagram of a circulation module according to an embodiment of the present application (the circulation module lower shell is not shown);

FIG. 9 is a schematic assembled structural diagram of the circulation module according to: an embodiment of the present application (the circulation module lower shell is not shown);

FIG. 10 is a schematic structural top view of the circulation module according to an embodiment of the present application;

FIG. 11 is a schematic diagram of a circulation process of a wet circulation airflow according to an embodiment of the present application;

FIG. 12 is a schematic diagram of a partial structure of a drying module according to a seventh implementation of the present application;

FIG. 13 is a schematic diagram of a partial structure of a drying module according to an eighth implementation of the present application;

FIG. 14 is a schematic exploded diagram of a partial structure of a drying module according to a ninth implementation of the present application;

FIG. 15 is a schematic diagram of a partial structure of a drying module according to a tenth implementation of the present application;

FIG. 16 is a schematic exploded diagram of a partial structure of a drying module according to an eleventh implementation of the present application;

FIG. 17 is a schematic structural diagram of a regeneration module according to a twelfth implementation of the present application;

FIG. 18 is a schematic structural diagram of a regeneration module according to a thirteenth implementation of the present application;

FIG. 19 is a schematic structural diagram of an air distribution member according to a fourteenth implementation of the present application;

FIG. 20 is a schematic structural diagram of a regeneration area in a regeneration circulation module of a drying module according to an embodiment of the present disclosure;

FIGS. 21-24 are schematic structural diagrams of a first connection component A in a regeneration circulation module of a drying module according to an embodiment of the present disclosure;

FIGS. 25-29 are schematic structural diagrams of a second connection component B in a regeneration circulation module of a drying module according to an embodiment of the present disclosure;

FIGS. 30-32 are schematic diagrams of a partial structure of the regeneration area in the regeneration circulation module of a drying module according to an embodiment of the present disclosure.

### REFERENCE NUMERALS

10—Circulation module; 20—Dehumidification module; 30—Regeneration module; 50—Corrugated hose; 51—Overlapping part: 52—Inlet duct; 100—Lower shell; 200—Rotary disk; 210—Rotary disk upper shell; 211—Second partition component; 220—Rotary disk lower shell; 221—First partition component; 2211—First partition body; 2212—Second partition body; 222—Diversion component; 2221—First diversion body; 2222—Second diversion body; 223—Air inlet; 224—Fixed shaft; 301—Regeneration fan; 302—Heating module; 310 Regeneration module upper shell; 311—Heater air inlet; 312—First top wall; 313—Third side wall; 314—Base; 318—Installation base; 320—Regeneration fan installation part; 321—Regeneration fan upper shell; 322—Regeneration fan lower shell; 330—Air distribution plate; 331—Vent; 340—Heating tube; 350—Thermal conductive component; 410—Condensation module upper shell; 420—Condensation module lower shell; 401—Condenser;
120—Circulation motor; 102—First air inlet; 103—First air outlet; 110—Impeller; 111—Circulation module upper shell; 112—Circulation module lower shell; 113—Sealing gasket; 130—Transitional component;
1101—Impeller main body: 1102—Blade; 1103—Fixed ring;
1111—Second side wall; 1112—First top plate; 1113—Upper shell connection component; 1114—Installation hole; 1115—Fixing clip;
1121—First side wall; 1122—First baseplate; 1123—Lower shell connection component;
A—First connection component; A01—First side surface; A11—Second installation outer base; A02—Second side surface; A3—Third side surface; B—Second connection component; B0—Second air inlet; B01—Fourth side surface; B02—Fifth side surface; B03—Sixth side surface; B1—Second air outlet; B2—Third connection body; B3—Fourth connection body.

### DETAILED DESCRIPTION

In order to better understand the above-mentioned technical solutions, the technical solutions of embodiments of the present application are described in detail below through the accompanying drawings and specific embodiments. It should be understood that the embodiments of the present application and the specific features in the embodiments are detailed descriptions of the technical solutions, of the embodiments of the present application, rather than limitations on the technical solutions of the present application. In the absence of conflict, the embodiments of the present application and the technical features in the embodiments may be combined with each other.

At present, the purpose of the present application in the prior art is to provide a drying module and a washer-dryer machine to solve the problem in the prior art that the dehumidified airflow still carries a high proportion of moisture, and the circulation utilization requires the process of heating, cooling and dehumidifying, and reheating the airflow, resulting in low dehumidification efficiency and high power consumption.

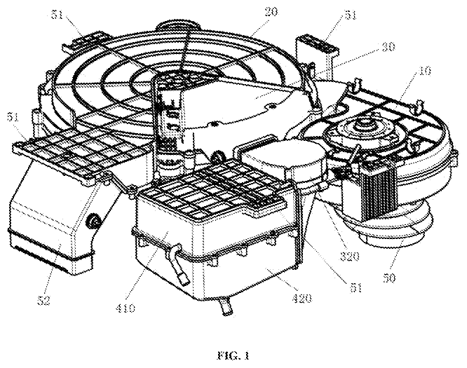

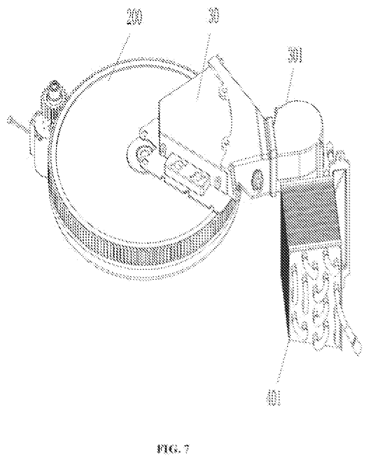

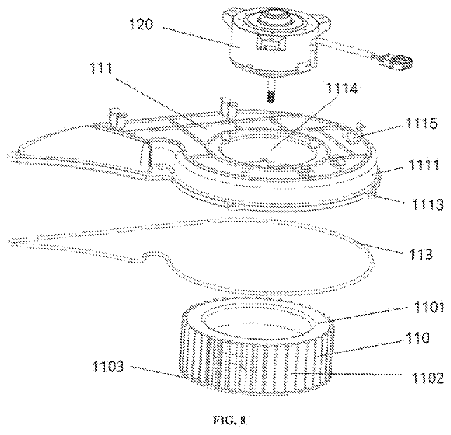

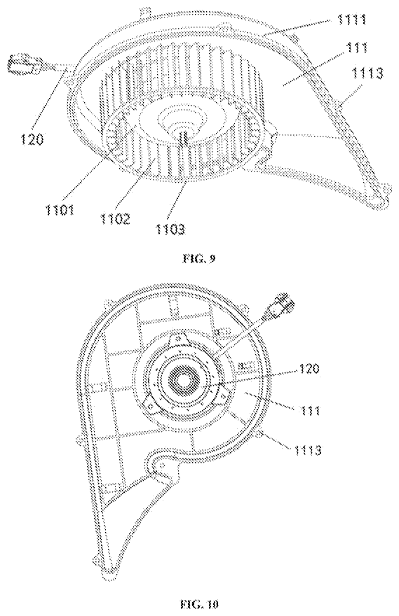

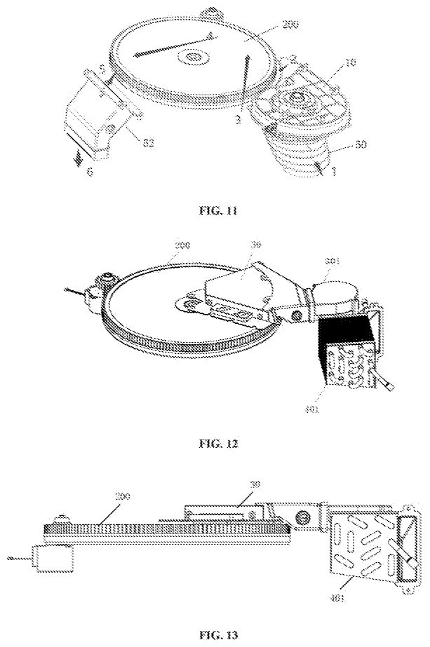

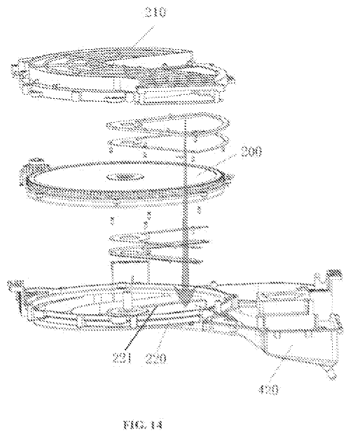

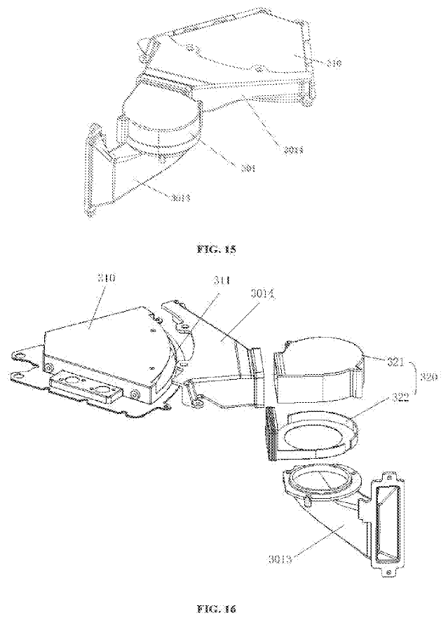

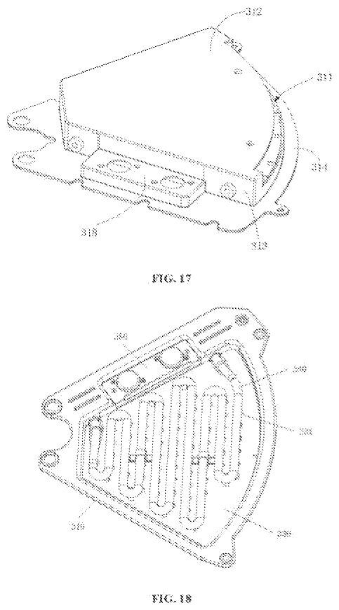

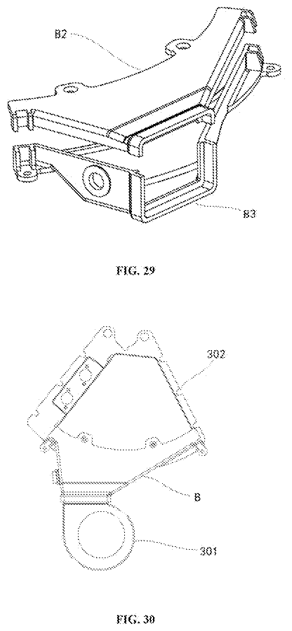

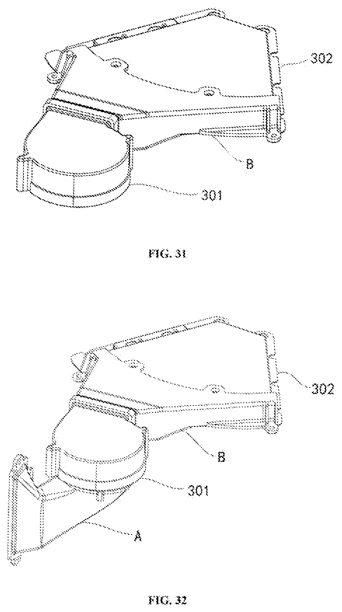

As shown in FIGS. 1 to 32, in order to solve the above problem, an embodiment of the present application provides a drying module, including: a circulation module 10, which is communicated with a drum of the washer-dryer machine and outputs a wet circulation airflow from the drum to a portion of a dehumidification module 20 in a circulation airflow channel for dehumidification: the dehumidification module 20, which is communicated with the circulation module 10 and the drum and is used to adsorb moisture of the wet circulation airflow from the drum; a regeneration module 30, which is installed on the dehumidification module 20, communicated with at least a portion of the dehumidification module 20 and is used to output a regeneration airflow to the dehumidification module 20 to desorb the moisture adsorbed by the dehumidification module 20; and a shell, which is provided with accommodating areas for respectively accommodating the circulation module 10, the dehumidification module 20 and the regeneration module 30.

In this embodiment, the portion of the dehumidification module 20 in the circulation airflow channel is used to adsorb moisture in the circulation airflow, while the portion of the dehumidification module 20 in a regeneration airflow channel utilizes the regeneration module 30 to desorb the moisture, wherein the circulation module 10 provides power for the airflow to be circulated between the drum and the dehumidification module 20, the circulation module 10 transports the wet circulation airflow from the drum to the dehumidification module 20 for adsorption and dehydration, and the dehumidification module 20 adsorbs moisture of the wet circulation airflow from the drum, so that a dry circulation airflow is output into the drum. The regeneration module 30 is communicated with the dehumidification module 20, so that the dry regeneration airflow is output to the portion of the dehumidification module 20 in the regeneration airflow channel to desorb moisture from the portion of the dehumidification module 20 in the regeneration airflow channel, so as to restore its moisture adsorption capacity. A condensation module 40 is communicated with a regeneration air outlet of the regeneration module 30, and is used to condense the regeneration airflow output by the regeneration module 30 to form a low-temperature dry regeneration airflow; and the condensate water formed in the condensation process is discharged.

In some examples, the drum may be an accommodating apparatus.

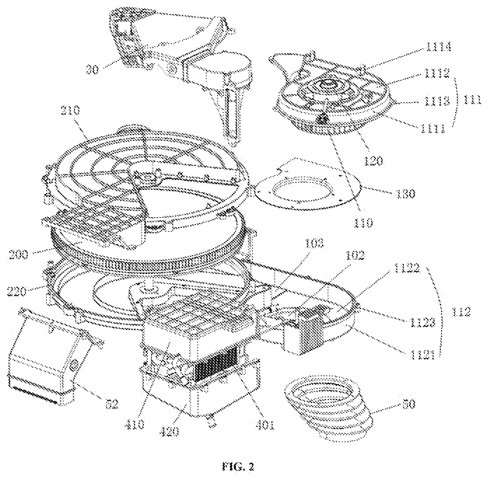

As shown in FIG. 1 and FIG. 2, preferably, the drying module further includes: the condensation module 40, which is used to condense the moisture desorbed by the dehumidification module 20. The shell is further provided with an accommodating area for the condensation module, and the accommodating areas for the circulation module 10, the dehumidification module 20, and the condensation module 40 are integrally formed.

The condensation module 40 is communicated with the regeneration air outlet of the regeneration module 30, and is used to condense the regeneration airflow output by the regeneration module 30 to form a low-temperature dry regeneration airflow, wherein the dehumidification module 20 is connected and fixed to a frame, and the circulation module 10 and/or the condensation module 40 are connected and fixed to the drum. Alternatively, at least one of the dehumidification module 20, the circulation module 10 and the condensation module 40 is fixedly connected to the frame, and the other modules are fixedly connected to the drum.

The dehumidification module 20, the circulation module 10 and the condensation module 40 are independent modules. The dehumidification module 20 and the regeneration module 30 installed thereon may be fixedly connected to the frame to reduce or eliminate the influence of the vibration of the drum on the dehumidification module 20, and at least one of the circulation module 10 and the condensation module 40 is fixedly connected to the drum. Of course, a regeneration fan 301 communicated with the regeneration module 30 may also be optionally fixed to the frame or the drum. Since the circulation module 10, the condensation module 40, the regeneration fan 301, etc. are not sensitive to vibration, they may be arranged according to an actual situation or requirements of space layout.

As shown in FIG. 1 and FIG. 2, preferably, the dehumidification module 20 includes a rotary disk 200 and a rotary disk upper shell 210 enclosing the rotary disk 200 therein, at least a portion of the rotary disk 200 is used to adsorb moisture in the wet circulation airflow; airflow channels are formed between the rotary disk 200 and top and bottom walls of the rotary disk upper shell 210; and an installation part for the regeneration module 30 is provided on the rotary disk. upper shell 210. The circulation module 10 is located upstream or downstream of the dehumidification module 20. The regeneration module 30 is installed on the installation part for the regeneration module 30, and the regeneration module 30 is adjacent to at least another portion of the rotary disk 200 to evaporate the moisture adsorbed on the rotary disk 200. When the rotary disk 200 rotates continuously inside the rotary disk upper shell 210, the wet circulation airflow passes through the airflow channels formed between the rotary disk 200 and the top wall and the bottom wall of the rotary disk upper shell 210, and at least a portion of the rotary disk 200 contacts the wet circulation airflow and adsorbs the moisture in the circulation airflow to obtain a dry circulation airflow, which passes through an object to be dried in the drum to form a wet circulation airflow again. When the rotary disk 200 rotates to the area where the regeneration module 30 installed on the rotary disk upper shell 210 is located, the regeneration module 30 evaporates the moisture adsorbed on the rotary disk 200. In this way, the circulation is repeated, and the rotary disk 200 continuously adsorbs moisture in the wet circulation airflow and restores the adsorption capacity by means of the regeneration module 30. Preferably, the circulation module 10 is located upstream of the dehumidification module 20, and blows the wet circulation airflow to the dehumidification module 20, so that the airflow circulates between the dehumidification module 20 and the drum. The condensation module 40 is communicated with the regeneration module 30, and condenses the regeneration airflow output by the regeneration module 30 to form a low-temperature dry airflow.

In some examples, the rotary disk upper shell 210 may be a rotary disk second shell.

In an embodiment of the present application, the circulation module 10, the dehumidification module 20 and the regeneration module 30 are connected by corrugated hoses,

In an embodiment of the present application, the dehumidification module 20 further includes: an air outlet channel, one end of which is communicated with the dehumidification module 20, and the other end of which is communicated with the drum through a first corrugated hose.

In this embodiment, the dehumidification module 20 and the interior of the drum are communicated through the first corrugated hose to prevent the air outlet channel and the dehumidification module 20 from being damaged by the rotation of the drum. The air outlet channel is a channel for the dry airflow, obtained by adsorbing moisture through the dehumidification module 20, to enter the drum. Optionally, a filter assembly or a valve is arranged in the air outlet channel to prevent impurities or moisture in the drum from entering the dehumidification module 20 through the air outlet channel, when the drying module is not in operation, thereby preventing the parts in the dehumidification module 20 from being damaged.

In an embodiment of the present application, the circulation module 10 and the condensation module 40 being connected and fixed to the drum is implemented as follows: the dehumidification module 20 and the circulation module 10 are communicated through a second corrugated hose; the regeneration module 30 and the condensation module 40 are communicated through a third corrugated hose; and the circulation module 10 is communicated with the drum.

In this embodiment, the dehumidification module 20 is fixed on the frame, and the circulation module 10 and the condensation module 40 are connected and fixed to the drum; the air inlet of the dehumidification module 20 and the air outlet of the circulation module 10 are communicated through the second corrugated hose; the regeneration module 30 and the air inlet of the condensation module 40 are communicated through the third corrugated hose; the air inlet of the circulation module 10 is communicated with the drum air outlet, so as to prevent the dehumidification module 20, the regeneration module 30 and the circulation module 10 from being damaged due to different amplitudes and frequencies of the vibration of the drum. The circulation module 10 is fixedly installed on the drum, and the air inlet of the circulation module 10 is communicated with the drum. Optionally, the air inlet of the circulation module 10 is fixedly connected to the drum air outlet.

In an embodiment of the present application, the circulation module 10 is connected and fixed to the drum; the condensation module 40 is connected and fixed to the frame; and the dehumidification module 20 and the circulation module 10 are communicated through the second corrugated hose.

In this embodiment, the dehumidification module 20 and the condensation module 40 are fixedly installed on the frame, and the circulation module 10 is fixedly installed on the drum. The air inlet of the dehumidification module 20 and the air outlet of the circulation module 10 are communicated through the second corrugated hose to prevent the dehumidification module 20 and the circulation module 10 from being damaged due to different amplitudes and frequencies of vibrations of the drum and the frame. The dehumidification module 20, the condensation module 40 and the regeneration module 30 are all fixedly connected to the frame, so the connection method of the air inlets and the air outlets among the three modules is not limited, and fixed connection is preferred.

In an embodiment of the present application, the condensation module 40 is connected and fixed to the drum; the circulation module 10 is connected and fixed to the frame; the regeneration module 30 and the condensation module 40 are communicated through the third corrugated hose; and the circulation module 10 and the drum are communicated through a fourth corrugated hose.

In an embodiment of the present application, the dehumidification module 20 further includes: an air inlet channel, which is installed on the drum, one end of which is fixedly connected to the drum, and the other end of which is communicated with the circulation module 10. A filter assembly is provided in the air inlet channel for filtering impurities in the circulation airflow. The filter assembly (which may be a filter screen) is provided in the air inlet channel to remove impurities in the circulation airflow, so as to prevent lint and dust impurities from entering the circulation module 10 and the dehumidification module 20, and in turn to prevent the above-mentioned modules from being blocked or prevent the impurities from burning. Since lint and dust impurities come from the drum, installing the air inlet channel on the drum is conducive to directly filtering the circulation airflow, thereby preventing the air inlet channel as well as the fourth corrugated hose and the circulation module 10 downstream thereof from being blocked.

As shown in FIGS. 1 and 2, in an embodiment of the present application, the regeneration module 30 includes: a heating module 302, an inlet end of which is provided with an installation part for a regeneration fan 301, and which is configured to desorb the moisture adsorbed on the dehumidification module 20; and the regeneration fan 301, installed on the installation part for the regeneration fan 301, communicated with the condensation module 40, and configured to transport the low-temperature dry regeneration airflow formed by condensation of the regeneration module 30 to the heating module 302. The heating module 302 performs heating to evaporate the moisture adsorbed by the dehumidification module 20, and the regeneration fan 301 transports a wind to the heating module 302 to form a high-temperature regeneration airflow, thereby accelerating the recovery of the moisture adsorption capacity of the dehumidification module 20.

In an embodiment of the present application, the condensation module 40 is provided with a cooling water inlet, a cooling water outlet and a condensate water drain outlet. The cooling water inlet is connected to a water inlet valve on the frame through a first hose, and the cooling water outlet and the condensate water drain outlet are communicated with a drain pipe of the washer-dryer machine to directly discharge the condensate water or cooling water.

As shown in FIGS. 2 to 5, the circulation module 10 may specifically include a circulation module shell, an impeller 110 and a circulation motor 120. The circulation module shell is provided with a first air inlet 102 and a first air outlet 103. The impeller 110 is arranged in the circulation module shell, the rotation axis of the impeller 110 is parallel to the axis of the first air inlet 102 and is substantially perpendicular to the axis of the first air outlet 103. The circulation motor 120 is connected and fixed to the circulation module shell, and the output shaft of the circulation motor 120 is connected and fixed to the impeller 110. The rotation axis of the impeller 110 corresponds to the first air inlet, that is, the rotation axis of the impeller 110 can pass through the first air inlet 102, so that the impeller 110 can face directly the first air inlet 102 and drive the airflow at the first air inlet 102 to cause the airflow to flow into the circulation module shell, and the airflow can be quickly drawn into the circulation module shell without increasing the rotation speed of the impeller 110. When the impeller 110 is driven by the circulation motor 120 to rotate, a centrifugal force is formed around the outer periphery of the impeller 110, and the airflow in the impeller 110 flows in the direction of the centrifugal force. At this time, the airflow spreads out from the outer periphery of the impeller 110, thereby changing the flow direction of the airflow; and a negative pressure is formed at and near the rotation axis of the impeller 110, which can increase the airflow sucked into the first air inlet 102. Therefore, by designing the circulation power in a wind supply method in which the circulation motor 120 controls the rotation of the impeller 110 to form the negative pressure, the related losses caused by the direct collision of strong wind with other components are effectively avoided. Traditional fans usually cause higher losses when the airflow changes its flow direction, while the circulation module provided by the embodiment of the present application provides power for the airflow to change its flow direction, thereby bringing more flexibility in the layout of the circulation module.

In an optional embodiment, the circulation module shell includes: a circulation module lower shell 112, provided with a first impeller accommodating area which is recessed; and a circulation module upper shell 111, provided with a second impeller accommodating area which is recessed, wherein the circulation module lower shell 112 is connected with the circulation module upper shell 111 in a matching manner, so that the first impeller accommodating area and the second impeller accommodating area form an impeller accommodating cavity in which the impeller 110 is located. The impeller accommodating cavity may be configured as a circle larger than the outer diameter of the impeller 110, and the axis of the impeller accommodating cavity is parallel to the rotation axis of the impeller 110, so that the airflow output by the rotation of the impeller 110 may be guided to flow out through inner side walls of the circulation module lower shell 112 and the circulation module upper shell 111.

In some examples, the circulation module upper shell 111 may be a circulation module second shell.

In an optional embodiment, the circulation module lower shell 112 includes a first baseplate 1122 and a first side wall 1121. The first side wall protrudes from the first baseplate and is arranged along the circumferential direction of the first baseplate 1122 to form the first impeller accommodating area. A first groove is arranged at the top of the first side wall 1121, and a scaling gasket 113 is arranged in the first groove. The circulation module upper shell 111 includes a first top plate 1112 and a second side wall 1111, wherein the second side wall protrudes from the first top plate and is arranged along the circumferential direction of the first top plate 1112 to form the second impeller accommodating area, and the top of the second side wall 1111 is provided with a first protrusion which matches the first groove. When the circulation module lower shell 112 and the circulation module upper shell 111 are connected, the first protrusion abuts against the scaling gasket 113. The circulation module lower shell 112 may be prepared by bending the baseplate upwards. Similarly, the circulation module upper shell 111 may be prepared by bending the top plate downwards. When assembling the circulation module lower shell 112 and the circulation module upper shell 111, the first protrusion squeezes the sealing gasket 113 in the first groove to deform the sealing gasket 113, so as to achieve an excellent sealing effect between the circulation module lower shell 112 and the circulation module upper shell 111.

In some examples, the circulation module lower shell 112 may be a circulation module first shell.

In an optional embodiment, the impeller 110 includes: an impeller main body 1101 and a fixing ring 1103 axially arranged opposite to the impeller main body 1101, wherein the impeller main body 1101 extends toward the fixing ring 1103 and is provided with an accommodating cavity for accommodating the circulation motor, one end of the circulation motor 120 is arranged in the accommodating cavity, and the output shaft of the circulation motor 120 is connected and fixed to the bottom of the impeller main body 1101; and blades 1102, wherein two ends of the blade 1102 are fixedly connected to the impeller main body 1101 and the fixing ring 1103 respectively, the blades 1102 are arranged at intervals around the impeller main body 1101, and the blades 1102 are arranged to be tilted forward along the rotation direction of the impeller. The impeller main body 1101 may include a cover plate at the top, and one end of the blade 1102 along its length direction is fixedly connected to the cover plate, so that the airflow sucked from the bottom of the impeller can be blocked by the cover plate and output radially from the impeller. The impeller main body 1101 extends toward the blade 1102, a recessed accommodating cavity is provided in the impeller main body 1101, and one end of the circulation motor 120 is embedded in this accommodating cavity, so that the overall axial length of the circulation fan is reduced, and the overall length of the circulation fan is reduced. The arrangement of the blade 1102 of being tilted forward along the rotation direction of the impeller can improve the air outlet efficiency of the impeller and is conducive to improving the noise reduction effect of the fan and improving the energy efficiency of the fan.

In an optional embodiment, a through-installation hole 1114 and positioning bumps are provided on the top of the first top plate 1112, and the installation hole 1114 is adapted to the circulation motor. The positioning bumps are arranged at intervals along the circumferential direction of the installation hole 1114, and the positioning bumps are inserted into installation bearing supports of the circulation motor, so that the circulation motor is fixed on the first top plate 1112. The installation bearing supports may be arranged on the shell of the circulation motor, and the installation bearing supports are arranged at one end of the shell of the circulation motor away from the output shaft. The installation bearing support may be provided with a positioning hole adapted to the positioning bump, and the positioning hole may be configured as a none-though hole. The installation bearing support is provided with a bolt hole communicated with the positioning hole. The positioning bump may be provided with a threaded hole arranged coaxially with and adapted to the bolt hole. The positioning bump is inserted into the positioning hole, and a bolt is screwed into the threaded hole through the bolt hole, so that the circulation motor is fixed on the first top plate 1112, and the circulation motor is embedded in the installation hole 1114 and extends downward. In this way, the installation part of the circulation motor is located outside the circulation module upper shell 111, which is convenient for the installation and removal of the circulation motor.

In an optional embodiment, the circulation module shell is in a shape of a volute, the circulation module shell has a contraction part extending in a direction perpendicular to the rotation axis of the impeller 110, and the first air outlet is communicated with the impeller accommodating cavity through the contraction part. The circulation module shell is in the shape of a volute, and since the volute has a unique shape, the airflow changes its flow direction after passing through the impeller 110 and is output from the contraction part, which can prevent the airflow from circulating in the impeller accommodating cavity all the time, meet the fluid design requirements and provide the maximum air volume and air speed for the airflow:

In the exemplary embodiment, the first air inlet 102 is located on the first baseplate 1122, and the first air inlet 102 is arranged coaxially with the installation hole 1114. The contraction part has an air outlet cavity. The first air inlet 102, the impeller accommodating cavity, the air outlet cavity and the first air outlet are sequentially connected, and the impeller accommodating cavity, the air outlet cavity and the first air outlet are located on the same horizontal plane. The contraction part has an air outlet cavity, and the airflow changes its flow direction after passing through the impeller 110 and flows to the first air outlet through the air outlet cavity. The air outlet cavity is substantially perpendicular to the rotation axis of the impeller 110, and the impeller accommodating cavity, the air outlet cavity and the first air outlet are substantially located on the same horizontal plane, so that the height dimension of the circulation module shell is reduced, the overall occupied space of the circulation module is reduced, and the height and volume of the whole washer-dryer machine using the circulation module are also reduced.

In an optional embodiment, the circulation module further includes a circulation air interface component, which is connected to the contraction part or is integrated with the circulation module shell. The circulation air interface component is configured in an are shape at a side thereof away from the contraction part, configured to gradually expand toward the side thereof away from the contraction part, and configured with an expansion air duct therein, and two ends of the expansion air duct are respectively communicated with the air outlet cavity and the first air outlet. The circulation air interface component may be configured as two separate shells, i.e., upper and lower shells, respectively connected to the circulation module upper shell 111 and the circulation module lower shell 112. The cross-sectional area of the expansion air duct gradually increases toward the side thereof away from the contraction part, and when the airflow enters the air outlet cavity and the expansion air duct after passing through the impeller 110, the dynamic pressure energy of the airflow is further converted into static pressure energy, thereby improving the conversion capacity of dynamic pressure energy and improving the working performance of the fan.

In an optional embodiment, lower shell connection components 1123 are provided on the first side wall 1121, and the lower shell connection components 1123 are arranged at intervals along the outer periphery of the first side wall 1121 and protrudes from the first side wall 1121. Upper shell connection components 1113 are provided on the second side wall 1111, and the arranging positions of the upper shell connection components 1113 correspond to those of the lower shell connection components 1123 one by one. The upper shell connection components 1113 are connected to the lower shell connection components 1123, so that the positions of the circulation module lower shell 112 and the circulation module upper shell 111 are relatively fixed. Both the upper shell connection components 1113 and the lower shell connection components 1123 may be provided with adapted bolt through holes into which bolts are inserted to achieve a detachable connection between the circulation module lower shell 112 and the circulation module upper shell 111.

In an optional embodiment, a fixing clip 1115 is provided on the circulation module shell, and the fixing clip 1115 is used to fix lines or pipelines, so that the wires of the circulation motor, or the water and gas pipelines on the whole machine can be better arranged.

In an optional embodiment, the circulation module further includes a transitional component 130 arranged on the circulation module lower shell 112 and adapted to the first impeller accommodating area. The transitional component is connected and fixed to the first baseplate 1122 and is provided with a through hole communicated with the first impeller accommodating area; the side of the transitional component away from the first impeller accommodating area is connected to the corrugated hose 50, which is connected to the air inlet of the lower shell through the transitional component 130. The transitional component may be provided with first transitional holes and second transitional holes which are both evenly distributed at intervals along the circumferential direction of the through hole. The diameter of the first air inlet 102 is smaller than the distribution diameter of the first transitional holes, an end of the corrugated hose 50 may be provided with corresponding threaded holes, and bolts are caused to pass through the first transitional holes and are screwed into the threaded holes to fix the corrugated hose 50 on the transitional component 130. The distribution diameter of the second transitional holes is larger than the diameter of the first air inlet 102, the first baseplate 1122 is provided with threaded holes corresponding to the second transitional holes, and bolts are caused to pass through the second transitional holes and are screwed into the threaded holes to fix the transitional component 130 on the first baseplate 1122. One side of the transitional component may be provided with a positioning sleeve, which may be inserted into the corrugated hose 50. When installing the corrugated hose 50, the corrugated hose 50 may be first fixed to the transitional component 130, and then the transitional component 130 may be fixed on the first baseplate 1122, so as to facilitate the installation and removal of the corrugated hose 50.

A second aspect of the present application provides a drying device including the above-mentioned circulation module. It is understandable that the drying device may further include the dehumidification module 20 and the regeneration module 30. The circulation module has a first circulation passage, which is communicated with the drum air outlet so that the wet circulation airflow in the drum enters the first circulation passage. The dehumidification module has a second circulation passage, and the dehumidification module is located downstream of the circulation module. The drum air outlet, the first circulation passage, the second circulation passage and the drum air inlet are connected in sequence to form a circulation passage. The dehumidification module includes a moisture adsorption and removal member, which is arranged on a second circulation passage and is used to adsorb moisture in the wet circulation airflow in the drum. The regeneration module 30 includes a regeneration member, which is arranged next to the moisture adsorption and removal member and is used to discharge at least a portion of the moisture adsorbed on the moisture adsorption and removal member. The circulation module provided by the embodiment of the present application can provide power for the wet circulation airflow, which is beneficial to the circulation of the airflow. The air inlet of the circulation fan is communicated with the drum air outlet, and the first air outlet 103 is communicated with the second circulation passage. The moisture adsorption and removal member is arranged on the second circulation passage and can first adsorb the moisture in the wet circulation airflow in the drum, so that the wet circulation airflow can be transformed into a dry circulation airflow, which enters the drum through the drum air inlet and fully contacts the clothes, thereby improving the drying efficiency and reducing the energy consumption. In order to cause the moisture adsorption and removal member to be used continuously and repeatedly, the moisture adsorbed on the moisture adsorption and removal member is discharged by the regeneration member. The regeneration member may be, for example, a heating member or an ultrasonic member, etc., and the moisture adsorbed on the moisture adsorption and removal member is removed by heating or ultrasonic dehumidification.

It will be appreciated that the above mentioned “arranged next to” may be “arranged adjacent to”.

A third aspect of the present application provides a washer-dryer machine including the above-mentioned drying device.

It can be understood that the washer-dryer machine further includes the drum, the axis of the drum is arranged in a horizontal direction, and the circulation module may be installed on the top of the drum. The first air inlet 102 is arranged downward, and is communicated with the drum air outlet through the corrugated hose 50. The arrangement of the corrugated hose 50 can reduce the vibration caused by the drum.

In some embodiments, the first airflow channel is communicated with the drum air outlet, and the second airflow channel is communicated with the drum air inlet. The wet circulation airflow in the drum passes through the first airflow channel and passes through the moisture adsorption area of the rotary disk 200 from top to bottom to reach the second airflow channel, and the moisture in the wet circulation airflow is adsorbed to form a dry circulation airflow.

In some embodiments, the lower shell 100 includes a circulation module lower shell 112, a circulation-fan accommodating area is provided in the circulation module lower shell 112, and the circulation-fan accommodating area is communicated with the first rotary disk accommodating area, wherein the circulation fan is installed in the circulation-fan accommodating area, the air inlet of the circulation fan is communicated with the drum air outlet, and the air outlet of the circulation fan is communicated with the second airflow channel. The wet circulation airflow discharged from the drum is drawn by the circulation fan and sent into the bottom of the rotary disk accommodating cavity, which can accelerate the diffusion of the wet circulation airflow in the second airflow channel, and is conducive to the circulation of the airflow.

In some examples, the lower shell 100 may be a first shell.

In some embodiments, the lower shell 100 further includes a rotary disk lower shell 220. The rotary disk lower shell 220 is provided with the first rotary disk accommodating area, and the first rotary disk accommodating area is provided with a first partition component 221, so as to partition the first rotary disk accommodating area into a dehumidification area and a regeneration area, wherein the air outlet of the circulation fan is communicated with the dehumidification area. A gap is formed between the bottom surface of the rotary disk 200 and the bottom wall in the dehumidification area of the rotary disk lower shell to form the second airflow channel. When the rotary disk 200 is working, the portion of the rotary disk 200 located in the dehumidification area can adsorb moisture in the wet circulation airflow entering the second airflow channel. During rotation of the rotary disk 200, when the portion of the rotary disk that has adsorbed moisture in the dehumidification area rotates to the regeneration area, dehydration and regeneration are performed.

In some embodiments, the drying module further includes the regeneration module 30, which is connected with the rotary disk upper shell 210 in a matching manner, and a regeneration module accommodating part of a substantially fan shape is formed on the rotary disk upper shell 210. The regeneration module 30 is installed in the regeneration module accommodating part, and the regeneration module 30 is located above the rotary disk 200. The regeneration module is used, for example, to heat the regeneration airflow to desorb the moisture adsorbed by the rotary disk 200, wherein the inner side of the regeneration module has an airflow space to form a third airflow channel. A gap is formed between the bottom surface of a portion of the rotary disk 200 and the inner wall of the regeneration area of the rotary disk lower shell 220 to form a fourth airflow channel. The regeneration module may include a heater to heat the regeneration airflow, and the heated regeneration airflow passes through the third airflow channel and passes through the rotary disk 200 from top to bottom to reach the fourth airflow channel, so as to dehydrates the portion of the rotary disk 200 in the regeneration area, During the rotation of the rotary disk 200, it passes through the dehumidification area and the regeneration area, which is a continuous circulation process of adsorbing and desorbing moisture.

In some examples, the rotary disk lower shell 220 may be a rotary disk first shell, and the rotary disk upper shell 210 may be a rotary disk second shell.

In some embodiments, the lower shell 100 further includes a condensation module lower shell 420 and a regeneration-fan installation part 320 on which the regeneration fan is installed. The condensation module lower shell 420 is provided with a condenser accommodating area respectively communicated with the fourth airflow channel and the inlet of the regeneration fan. The outlet of the regeneration fan is communicated with the third airflow channel. The regeneration airflow is drawn by the regeneration fan and sent into the third airflow channel, passes through the regeneration module, passes through the rotary disk 200 from top to bottom to reach the fourth airflow channel, and becomes a humid and hot regeneration airflow which enters the condenser 401 and the regeneration fan in sequence, so as to form a regeneration airflow in closed circulation. The humid and hot regeneration airflow enters the condenser 401 for heat exchange and cooling, the water vapor in the regeneration airflow is cooled to form condensate water to be discharged from the drain port of the condenser 401, and the dry low-temperature regeneration airflow enters the regeneration fan for the next circulation.

In some examples, the condensation module lower shell 420 may be a condensation module first shell.

In some embodiments, the lower shell 100 is configured as integrated. In an exemplary embodiment, the circulation module lower shell 112, the rotary disk lower shell 220, the condensation module lower shell 420 and the regeneration-fan installation part 320 are integrally formed. An overlapping part 51 may be arranged in the periphery of the lower shell 100; and the overlapping part 51 may be arranged at intervals in the circumferential direction of the lower shell 100, so that the entire drying module may be installed on the frame through the overlapping part 51. In this way, the entire drying module can be organically integrated into a whole, simplifying its assembly process in the washer-dryer machine, and also facilitating further optimization design of the overall size of the washer-dryer machine. In order to minimize the overall size of the washer-dryer machine, the drying module may be installed on the top of the drum. The drying module is arranged horizontally, that is, the rotating axes of the rotary disk 200, the circulation fan, and the regeneration fan are substantially parallel to each other, and are perpendicular to the upper shell of the washer-dryer machine/perpendicular to the rotating axis of the drum of the washer-dryer machine. In this way, the overall height of the washer-dryer machine depends on the diameter of the drum and the thickness of the shell arranged above the drum. The circulation fan, regeneration fan, condenser, etc. can all be arranged above the drum. Since the drum is approximately horizontally cylindrical, there will be larger vertical space above the drum and on both sides of the maximum diameter of the drum for the installation of components such as the circulation fan, regeneration fan, condenser, etc.

In some examples, the circulation module lower shell 112 may be a circulation module first shell.

In some embodiments, in order to make the entire drying module more securely installed, the overlapping part 51 may be provided on the rotary disk upper shell 210, the circulation module upper shell 111 and/or the condensation module upper shell 410, etc., which are not listed one by one here.

In some examples, the rotary disk upper shell 210 may be a rotary disk second shell, the circulation module upper shell 111 may be a circulation module second shell, and the condensation module upper shell 410 may be a condensation module second shell.

In some embodiments, the air inlet of the circulation fan is flexibly connected to the drum air outlet, and the rotary disk upper shell 210 is flexibly connected to the drum air inlet, so that the first airflow channel is communicated with the drum air inlet. The flexible connection may be, for example, a connection by the corrugated hose 50. By flexibly connecting with the drum air inlet and the drum air outlet, the vibration of the drum can be prevented from being passed to the entire drying module, especially, the vibration can be prevented from affecting the rotary disk member. The rotary disk upper shell 210 may be provided with an air outlet channel 203, which is transitionally connected to the inlet duct 52. The inlet duct 52 and the drum air inlet may also be flexibly connected, for example, by the corrugated hose 50.

In some embodiments, the first partition component 221 is arranged in the radial direction of the rotary disk lower shell 220, and a rotary wheel installation area is formed at the center of the first rotary disk accommodating area. The first partition component 221 arranged approximately radially makes the dehumidification area and the regeneration area both approximately fan-shaped, wherein the area of the dehumidification area may be set to 2-3 times. the area of the regeneration area. The area of the dehumidification area may be set to be larger than the area of the regeneration area, so that most of the rotary disk 200 is in the dehumidification area, thereby further improving the moisture adsorption efficiency and moisture adsorption effect of the rotary disk 200. In order to prevent the wet circulation airflow discharged from the drum from intercommunicating with the regeneration airflow, a certain dynamic sealing arrangement may be formed between the first partition component 221 and the rotary disk 200. When the rotary disk 200 rotates to the regeneration area, the regeneration airflow heats this portion of the rotary disk 200, so that the moisture in this portion evaporates quickly and is taken away by the regeneration airflow to enter the condenser. In this way, the rotary disk 200 always has a good water adsorption capacity, thereby improving the moisture adsorption efficiency and effect.

In an exemplary embodiment, the rotary disk lower shell 220 may be provided with the first rotary disk accommodating area, the rotary disk lower shell 220 may include a baseplate and a circumferential side wall protruding from the baseplate, and such formed recessed part is the first rotary disk accommodating area. Similarly, the rotary disk upper shell 210 may be provided with a second rotary disk accommodating area which is composed of the top wall and the circumferential side wall of the rotary disk upper shell 210, and a second partition component 211 formed by the radial side wall of the upper shell corresponding to the position of the first partition component 221. Structures of the recessed parts of the rotary disk upper shell 210 and the rotary disk lower shell 220 are arranged oppositely. When the rotary disk upper shell 210 and the rotary disk lower shell 220 are connected in a matching manner, the first rotary disk accommodating area and the second rotary disk accommodating area can be caused to form the rotary disk accommodating cavity. Since there is an airflow passing through the rotary disk accommodating cavity, a sealing connection may be arranged between the rotary disk upper shell 210 and the rotary disk lower shell 220. For example, a groove or a flange is respectively provided on the rotary disk upper shell 210 or the rotary disk lower shell 220, and a scaling strip is provided in the groove. When the rotary disk upper shell 210 is connected with the rotary disk lower shell 220 in a buckling manner, the flange presses against the sealing strip in the groove to achieve scaling. The circulation module lower shell 112 and the circulation module upper shell 111 are connected in a matching manner to form a circulation fan accommodating cavity, and the condensation module lower shell 420 and the condensation module upper shell 410 are connected in a matching manner to form a condenser accommodating cavity.

In some embodiments, the first partition component 221 includes at least a first partition body 2211 and a second partition body 2212. The first partition body 2211 and the second partition body 2212 are both arranged along the radial direction of the rotary disk lower shell 220, one ends of the first partition body 2211 and the second partition body 2212 are both connected to the side inner wall of the rotary disk lower shell 220, and the other ends of the first partition body 2211 and the second partition body 2212 intersect at the center of the rotary disk lower shell to form a rotation axis area of the rotary disk 200, so that the first partition component 221 is V-shaped as a whole. An arc transition connection is provided at the intersection between the first partition body 2211 and the second partition body 2212. The first partition component 221 may be configured as a baseplate protruding from the rotary disk lower shell 220, so that a gap is formed between the bottom surface of the rotary disk 200 and the baseplate of the rotary disk lower shell 220 to form the second airflow channel and the fourth airflow channel. By configuring the first partition component 221 in a V-shape, the first rotary disk accommodating area may be partitioned into the dehumidification area and the regeneration area, and the dehumidification area and the regeneration area may be partitioned into a sector shape. Therefore, it is beneficial for the rotary disk 200 to circularly pass through the dehumidification area and the regeneration area during rotation to continuously adsorb and desorb moisture, so that the rotary disk 200 always has a good water adsorption capacity, thereby improving the efficiency and effect of moisture adsorption.

In some embodiments, the rotary disk upper shell 210 is provided with the second partition component 211 to partition the rotary disk upper shell 210 into a dehumidification area and a regeneration module installation area. The second partition component 211 and the first partition component 221 are arranged oppositely on the rotary disk upper shell 210 and the rotary disk lower shell 220 respectively, and the rotary disk 200 is located between the second partition component 211 and the first partition component 221. In order to prevent the wet circulation airflow discharged from the drum from intercommunicating with the regeneration airflow, the first partition component 221 and the second partition component 211 may form a dynamic sealing arrangement with the rotary disk 200, so that it is beneficial for the rotary disk 200 to pass through the dehumidification area and the regeneration area during rotation to continuously adsorb moisture and be dehydrated and dried, so that the rotary disk 200 always has a good water adsorption capacity, thereby improving the efficiency and effect of moisture adsorption.

In some embodiments, a third first partition body may be provided on the rotary disk lower shell 220, and a third second partition body may be provided at a corresponding position on the rotary disk upper shell 210. When viewed in the rotation direction of the rotary disk 200, the third first and second partition bodies may be provided downstream of the regeneration area or upstream of the dehumidification area, so that the entire rotary disk shell space is partitioned into three spaces, which can respectively realize the water adsorption and dehumidification function, the regeneration and desorption function, and the cooling function. In this embodiment, the substantially fan-shaped area between the third first and second partition bodies and the regeneration area is a cooling area for realizing the cooling function of the rotary disk 200. The advantage of such arrangement is that, after the rotary disk passes through the regeneration area to be heated and desorbed of moisture, there will be high-temperature residual heat on the rotary disk 200, and the high-temperature residual heat will affect the ability of the rotary disk 200 to adsorb moisture after entering the dehumidification area, Therefore, the cooling area is arranged between the regeneration area and the dehumidification area to give the rotary disk 200 a buffer cooling effect, which can improve the water adsorption efficiency.

In some embodiments, the drying module may include the shell, which has a rotary disk accommodating cavity, a circulation fan accommodating cavity, a condenser accommodating cavity, a regeneration module accommodating part and a regeneration fan installation part, and the drum air outlet, the circulation fan, the rotary disk accommodating cavity and the drum air inlet are connected in sequence, so that the wet circulation airflow discharged from the drum may be drawn by the circulation fan and sent into the bottom of the rotary disk accommodating cavity, the wet circulation airflow passes through the rotary disk 200 from bottom to top, and the rotary disk 200 adsorbs moisture in the wet circulation airflow, and thus the wet circulation airflow may be transformed into a dry circulation airflow, which enters the drum through the drum air inlet, fully contacts with the clothes, thereby improving the drying efficiency. The regeneration module 30, the condenser 401 and the regeneration fan form closed circulation communication. The regeneration airflow is drawn by the regeneration fan and sent into the regeneration module. The regeneration airflow is heated by the regeneration module 30 and passes through the rotary disk 200 from top to bottom. The heated regeneration airflow desorbs the moisture adsorbed in the rotary disk 200, takes away the water vapor, and enters the condenser for heat exchange. The water vapor in the regeneration airflow is cooled to form condensate water to be discharged from the condenser, and the dry low-temperature regeneration airflow enters the regeneration fan for the next circulation.

The shell may be provided with the overlapping parts 51, which may be arranged at intervals along the circumferential direction of the shell, and the entire drying module may be installed on the frame through the overlapping parts. The shell includes the lower shell 100, the rotary disk upper shell 210, the circulation module upper shell 111, and the condensation module upper shell 410, etc. In order to minimize the overall size of the washer-dryer machine, the drying module may be installed on the top of the drum of the washer-dryer machine. The drying module is arranged horizontally, that is, the rotating axes of the rotary disk 200, the circulation fan, and the regeneration fan are all substantially parallel to each other, and substantially perpendicular to the upper shell of the washer-dryer machine/perpendicular to the rotating axis of the drum of the washer-dryer machine. In this way, the overall height of the washer-dryer machine depends on the diameter of the drum and the thickness of the shell placed above the drum. The circulation fan, the regeneration fan, the condenser, etc. may all be arranged above the drum. Since the drum is approximately horizontally cylindrical, there will be a larger vertical space above the drum for the installation of components such as the circulation fan, the regeneration fan, and the condenser. The circulation fan in the embodiment of the present application may include the circulation motor and the impeller, wherein the circulation motor drives the impeller to rotate to change the flow direction of the airflow and provide power for the wet circulation airflow.

In some embodiments, the lower shell may be configured as integrated, which can facilitate the overall installation of the drying module. Installing the drying module on the top of the drum of the washer-dryer machine can avoid the vibration of the drum from affecting the entire drying module to a certain extent. The lower shell 100 may include the circulation module lower shell 112, the rotary disk lower shell 220, the condensation module lower shell 420 and the regeneration-fan installation part 320, and the lower shell may be formed in an integrated manner. In this embodiment, the regeneration fan is purchased as a whole machine, so only the regeneration-fan installation part 320 is arranged. The rotary disk lower shell 220 may be provided with the first rotary disk accommodating area. In an exemplary embodiment, the rotary disk lower shell 220 may include a baseplate and a circumferential side wall protruding from the baseplate, and such formed recessed part is the first rotary disk accommodating area. Similarly, the rotary disk upper shell 210 may be provided with the second rotary disk accommodating area, and structures of the recessed parts of the rotary disk upper shell 210 and the rotary disk lower shell 220 may be symmetrically arranged. When the rotary disk upper shell 210 and the rotary disk lower shell 220 are connected in a matching manner, the first rotary disk accommodating area and the second rotary disk accommodating area can be caused to form the rotary disk accommodating cavity. Since there is an airflow passing through the rotary disk accommodating cavity, a scaling connection may be arranged between the rotary disk upper shell 210 and the rotary disk lower shell 220. For example, a groove is provided on the rotary disk upper shell 210 or the rotary disk lower shell 220, and a sealing strip is provided in the groove. When the rotary disk upper shell 210 is connected with the rotary disk lower shell 220 in a buckling manner, sealing is achieved. The circulation module lower shell 112 and the circulation module upper shell 111 are connected in a matching manner to form a circulation fan accommodating cavity, and the condensation module lower shell 420 and the condensation module upper shell 410 are connected in a matching manner to form a condenser accommodating cavity.

In some embodiments, the drying module may specifically include: the shell, which is provided with the rotary disk-member accommodating cavity; a rotary disk member, which is installed in the rotary disk-member accommodating cavity, wherein the rotary disk member includes the rotary disk 200, at least a portion of the rotary disk 200 is used to adsorb moisture in the wet circulation airflow, gaps are arranged between both sides of the rotary disk 200 and the first inner wall and the second inner wall of the shell respectively to form airflow channels, the first inner wall and the second inner wall are arranged opposite to each other, and the first inner wall or the second inner wall is substantially parallel with the two sides of the rotary disk 200; and at least one diversion component 222, which is arranged on at least one of the first inner wall or the second inner wall in an encircled manner and is used to divert the airflow flowing into the airflow channel. In some embodiments, the rotary disk member may include the rotary disk 200 and a driving assembly, and the driving assembly may include a motor which can drive the rotary disk 200 to rotate. The rotary disk 200 may be made of a material with good hygroscopic performance, such as zeolite, lithium chloride, silica gel, modified silica gel or 13X (sodium X type) molecular sieve. The wet circulation airflow flowing into the airflow channel at one side of the rotary disk 200 passes through the rotary disk 200 to reach the airflow channel on the other side. The rotary disk 200 adsorbs moisture in the wet circulation airflow, so that the wet circulation airflow can be transformed into a dry circulation airflow. Since the communication between the air outlet of the circulation fan and the rotary disk-member accommodating cavity is substantially along the tangential direction of the rotary disk, and the circulation airflow has a certain flow velocity while the wet circulation airflow has a high moisture content, the wet circulation airflow will escape away from the rotation center of the rotary disk under the action of centrifugal force. The airflow is usually formed at the larger diameter of the rotary disk 200, and the airflow is small in the area close to the rotation center of the rotary disk, so that the main moisture adsorption portion of the rotary disk 200 is at the larger diameter, affecting the moisture adsorption efficiency and the moisture adsorption utilization rate of the rotary disk. To this end, the diversion component 222 is arranged on the bottom wall of the shell in an encircled manner to divert the wet circulation airflow flowing into the airflow channel into one portion entering the area close to the center of the circle and the other portion entering the area close to the outer periphery of the rotary disk 200. In this way, the wet circulation airflow flowing into the airflow channel is more dispersed and more uniform, and the airflow can contact the rotary disk 200 with a larger area, thereby improving the moisture adsorption efficiency of the rotary disk 200.

In some embodiments, the shell includes: the rotary disk lower shell 220, which is provided with the first rotary disk accommodating area; and the rotary disk upper shell 210, which is provided with the second rotary disk accommodating area, wherein the rotary disk upper shell is connected with the rotary disk lower shell in a matching manner, so that the first rotary disk accommodating area and the second rotary disk accommodating area form the rotary disk-member accommodating cavity. A gap is formed between the top surface of the rotary disk 200 and a portion of the inner top wall of the rotary disk upper shell 210 to form a first airflow channel. A gap is formed between the bottom surface of the rotary disk 200 and a portion of the bottom wall of the rotary disk lower shell to form a second airflow channel. The second airflow channel is communicated with the drum air outlet, and the first airflow channel is communicated with the drum air inlet, so that the wet circulation airflow in the drum passes through the second airflow channel and passes through the rotary disk 200 to reach the first airflow channel. As an example, the diversion component 222 is arranged on the bottom wall of the rotary disk lower shell 220 in an encircled manner to divert the airflow flowing into the second airflow channel. For example, the wet circulation airflow discharged from the drum enters the bottom of the rotary disk-member accommodating cavity, that is, the wet circulation airflow diffuses in the second airflow channel. When the diversion component 222 is arranged on the inner bottom wall of the rotary disk lower shell in an encircled manner, the diversion component 222 can first divert the incoming wet circulation airflow into one portion entering the area close to the center of the circle and the other portion entering the area close to the outer periphery of the rotary disk 200, so that the wet circulation airflow flowing into the airflow channel is more dispersed and more uniform. The wet circulation airflow then passes through the rotary disk 200 from bottom to top, and the rotary disk 200 adsorbs moisture in the wet circulation airflow to transform the wet circulation airflow into a dry circulation airflow, which can improve the moisture adsorption efficiency of the rotary disk 200. The dry circulation airflow flows through the first airflow channel to the drum air inlet and enters the drum and fully contacts the clothes, thereby improving the drying efficiency, and reducing energy consumption.

In some embodiments, the at least one diversion component 222 is arranged in the dehumidification area of the first rotary disk accommodating area to partition the dehumidification area into at least a first diversion area and a second diversion area. A second air inlet 223 is arranged on the side wall of the rotary disk lower shell 220, and one end of the diversion component 222 abuts against the second air inlet 223 to partition the second air inlet 223 into at least a first sub-port and a second sub-port. The first sub-port is communicated with the first diversion area, the second sub-port is communicated with the second diversion area, and so on. The diversion component 222 partitions the second air inlet 223 into the first sub-port and the second sub-port, so that the wet circulation airflow is diverted at the second air inlet 223 by the diversion component 222 and the diverted airflows enter two diversion areas near the center of circle and the outer periphery, namely, the first diversion area and the second diversion area. In this way, the wet circulation airflow is reasonably diverted, the wet circulation airflow flowing into the first airflow channel is more dispersed and more uniform, and the airflow can contact the rotary disk 200 with a larger area, which can improve the moisture adsorption efficiency of the rotary disk 200. It is understandable that for the dehumidification area of the first rotary disk accommodating area, more than two diversion components 222 may be provided, and they may be arranged in parallel, thereby partitioning the dehumidification area into a plurality of diversion areas.

In some embodiments, when the rotary disk 200 is rotating, in order to prevent the diversion component 222 from interfering with the rotary disk 200, a preferred solution is that the diversion component 222 protrudes from the bottom wall of the rotary disk lower shell 220, and the height of the diversion component 222 is limited to not contacting the rotary disk 200, so that interference is avoided and an airflow scaling arrangement is formed between at least two diversion areas. The diversion component 222 protrudes from the bottom wall of the rotary disk lower shell 220, so that a gap is formed between the bottom surface of the rotary disk 200 and the bottom wall of the rotary disk lower shell 220, that is, the second airflow channel is partitioned into the first diversion area and the second diversion area.

In some embodiments, the first partition component 221 is arranged along the radial direction of the rotary disk lower shell 220, so that the dehumidification area and the regeneration area are both substantially fan-shaped, wherein the area of the dehumidification area may be set to be 1.5-4 times the area of the regeneration area. The area of the dehumidification area may be set to be larger than the area of the regeneration area, so that most of the rotary disk 200 is in the dehumidification area, thereby further improving the moisture adsorption efficiency and effect of the rotary disk 200. In order to prevent the wet circulation airflow discharged from the drum from intercommunicating with the regeneration airflow, a dynamic scaling arrangement may be provided between the first partition component 221 and the rotary disk 200. Of course, a sealing component, such as a flexible scaling component, may also be arranged between the first partition component 221 and/or the second partition component 211 and the rotary disk, and the sealing component is fixedly arranged on the first partition component 221 and/or the second partition component 211. When the rotary disk 200 rotates to the regeneration area, the regeneration airflow heats this portion of the rotary disk 200, so that the moisture in this portion is quickly desorbed and carried away by the regeneration airflow to enter the condenser. In this way, the rotary disk 200 always has a good water adsorption capacity, thereby improving the efficiency and effect of moisture adsorption.

In some embodiments, the first partition component 221 includes at least the first partition body 2211 and the second partition body 2212. The first partition body 2211 and the second partition body 2212 are both arranged along the radial direction of the rotary disk lower shell 220, one ends of the first partition body 2211 and the second partition body 2212 are both connected to the side inner wall of the rotary disk lower shell 220, and the other ends of the first partition body 2211 and the second partition body 2212 intersect at the central area of the rotary disk lower shell 220, so that the first partition component 221 is substantially V-shaped. An arc transition connection is arranged at the intersection between the first partition body 2211 and the second partition body 2212. The first partition component 221 may be configured to protrude from the baseplate of the rotary disk lower shell 220, so that a gap is formed between the bottom surface of the rotary disk 200 and the baseplate of the rotary disk lower shell 220 to form the second airflow channel. By configuring the first partition component 221 in a V shape, the first rotary disk accommodating area can be partitioned into a dehumidification area and a regeneration area, and the dehumidification area and the regeneration area can be partitioned to have a fan shape. Therefore, it is beneficial for the rotary disk 200 to circularly pass through the dehumidification area and the regeneration area during rotation to continuously adsorb and desorb moisture, so that the rotary disk 200 always has a good water adsorption capacity, thereby improving the efficiency and effect of moisture adsorption. The intersection between the first partition body 2211 and the second partition body 2212 is provided with the are transition connection, so that the wet circulation airflows diverted can be better guided. At the intersection between the first partition body 2211 and the second partition body 2212, that is, at the central area of the rotary disk lower shell 220, an upwardly protruding fixed shaft 224 may be provided, the rotary disk 200 is sleeved on the fixed shaft 224 at the center thereof, and the rotary disk 200 can rotate around the fixed shaft 224.

In some embodiments, the first diversion area is constituted by the inner arc side wall of the diversion component 222 and the first partition component 221, and the second diversion area is constituted by the outer are side wall of the diversion component 222 and the inner side wall of the rotary disk lower shell 220. The diversion component 222 is located between the first partition component 221 and the inner side wall of the rotary disk lower shell 220, and is arranged on the bottom wall of the rotary disk lower shell 220 in an encircled manner, so the wet circulation airflow entering the second airflow channel is more in line with the flow direction of the fluid. After the airflow quickly flows into the second airflow channel from the air outlet of the circulation fan, under the action of the centrifugal force, it diffuses along the side wall of the diversion component 222 and the inner side wall of the rotary disk lower shell 220 to the other end opposite to the air inlet 223, so that the airflow may have more time to contact the rotary disk 200, which is more conducive to adsorbing the moisture from the wet circulation airflow, instead of passing through the rotary disk 200 from bottom to top at the air inlet 223 and then directly entering the first airflow channel, thereby further improving the moisture adsorption efficiency and effect of the rotary disk 200.

In some embodiments, the second air inlet 223 is located near the first partition body 2211. The diversion component 222 includes a first diversion body 2221 and a second diversion body 2222 smoothly connected to one end of the first diversion body 2221, the first diversion body is substantially parallel to the first partition body 2211, and the first diversion body 2221 is spaced apart from the first partition body 2211. The end of the second diversion body 2222 away from the first diversion body 2221 is connected to the second partition body, and the second diversion body 2222 is configured in an are shape and may be arranged to be parallel to the inner side wall of the lower shell. After the wet circulation airflow enters from the second air inlet 223, it is guided by the first diversion body 2221 and the second diversion body 2222, and under the action of the centrifugal force, it is not only effectively diverted, but also more conducive to diffusion in the second airflow channel. Of course, the diversion component 222 may also be an integral component parallel to the inner side wall of the lower shell.

In some embodiments, the second diversion body 2222 is coaxially arranged with the side wall of the rotary disk lower shell 220. The second diversion body 2222 is configured in an are shape, and the are center of the second diversion body 2222 is arranged concentrically with the are center of the side wall of the rotary disk lower shell 220, that is, being concentrically with the rotation center of the rotary disk 200, which is more in line with the design of fluid dynamics and has better guidance for the wet circulation airflow entering from the second air inlet 223. Preferably, the second diversion body 2222 may be arranged at ½ of the radius of the side wall of the rotary disk lower shell 220 to achieve effective and uniform diversion of the incoming wet circulation airflow.

In some embodiments, there may be more than two diversion components 222, which can evenly or unevenly partition the second airflow channel into multiple diversion areas, thereby further reducing the influence of the centrifugal force on the adsorption of moisture in the airflow. The specific configuration may be the same or similar to that in the above-mentioned embodiments.

In some embodiments, the drying module may specifically include: the circulation module 10 and the dehumidification module 20. The circulation module 10 has a first circulation passage, which is communicated with the drum air outlet so that the wet circulation airflow in the drum enters the first circulation passage. The dehumidification module 20 is located downstream of the circulation module 10 and has a second circulation passage, which is communicated with the drum air inlet. The drum air outlet, the first circulation passage, the second circulation passage and the drum air inlet are communicated in sequence to form a circulation passage. The dehumidification module 20 includes the rotary disk member, at least a portion of which is arranged on the second circulation passage, and the rotary disk member is used to adsorb moisture of the wet circulation airflow from the drum, wherein the wet circulation airflow in the drum passes through the first circulation passage and the second circulation passage in sequence and is transformed into a dry circulation airflow. The circulation module 10 may include the circulation fan. The arrangement of the circulation fan can provide power for the wet circulation airflow, which is beneficial to the circulation of the airflow. The air inlet of the circulation fan is communicated with the drum air outlet, and the air outlet of the circulation fan is communicated with the second circulation passage. The rotary disk member is arranged on the second circulation passage. The rotary disk member can first adsorb moisture in the wet circulation airflow from the drum to transform the wet circulation airflow into a relatively dry circulation airflow, which enters the drum through the drum air inlet and fully contacts with the clothes, thereby improving the drying efficiency and reducing energy consumption.

In some embodiments, the dehumidification module 20 further includes: the rotary disk lower shell 220, which is provided with the first rotary disk accommodating area; the rotary disk upper shell 210, which is provided with the second rotary disk accommodating area, wherein the rotary disk upper shell 210 is connected with the rotary disk lower shell 220 in a matching manner, so that the first rotary disk accommodating area and the second rotary disk accommodating area form the rotary disk-member accommodating cavity; and the rotary disk member, which is installed in the rotary disk-member accommodating cavity. The rotary disk member includes the rotary disk 200, a gap is formed between the top surface of the rotary disk 200 and a portion of the top wall of the rotary disk upper shell 210 to form the first airflow channel, a gap is formed between the bottom surface of the rotary disk 200 and a portion of the bottom wall of the rotary disk lower shell 220 to form the second airflow channel, and the second airflow channel; the rotary disk 200 and the first airflow channel form a second circulation passage, wherein the second airflow channel is communicated with the first circulation passage, and the first airflow channel is communicated with the drum air inlet, so that the wet circulation airflow in the drum passes through the second airflow channel and passes through the rotary disk 200 to reach the first airflow channel. Specifically, the rotary disk 200 constitutes a portion of the rotary disk member, and the rotary disk member may further include a driving assembly. The driving assembly may include a motor, and the motor may drive the rotary disk 200 to rotate. The rotary disk 200 may be made of a material with good moisture adsorption and desorption performance, such as zeolite, lithium chloride, silica gel, modified silica gel or 13X (sodium X type) molecular sieve. The wet circulation airflow discharged from the drum enters the bottom of the rotary disk accommodating cavity and diffuses in the second airflow channel. The wet circulation airflow passes through the rotary disk 200 from bottom to top, and the rotary disk 200 adsorbs the moisture in the wet circulation airflow, so that the wet circulation airflow can be transformed into a dry circulation airflow, which enters the drum through the drum air inlet, fully contacts with the clothes, thereby improving the drying efficiency and reducing energy consumption. The embodiment of the present application adopts the rotary disk 200 to adsorb the moisture in the wet circulation airflow, which can avoid the decrease in the moisture adsorption capacity for the humid air caused by the use of an evaporator.

In some embodiments, the circulation module 10 includes: the circulation module shell, which has the impeller accommodating cavity and is provided with the first air inlet 102 and the first air outlet 103; the impeller 110, which is arranged in the impeller accommodating cavity, wherein the rotation axis of the impeller is substantially parallel to the axis of the first air inlet and is substantially perpendicular to the axis of the first air outlet; and the circulation motor 120, which is connected and fixed to the circulation module shell, wherein the output shaft of the circulation motor 120 is connected and fixed to the impeller 110. The first air inlet 102, the impeller accommodating cavity and the first air outlet 103 form the first circulation passage, wherein the first air inlet 102 is communicated with the drum air outlet, and the first air outlet 103 is communicated with the second circulation passage, so that the wet circulation airflow in the drum enters the first circulation passage and the second circulation passage in sequence. The rotation axis of the impeller 110 corresponds to the first air inlet, that is, the rotation axis of the impeller 110 can pass through the first air inlet 102, so that the impeller 110 can face directly the first air inlet 102 and drive the airflow at the first air inlet 102, causing the airflow to flow into the circulation module shell, and the airflow can be quickly drawn into the circulation module shell without increasing the rotation speed of the impeller 110. When the impeller 110 is driven to rotate by the circulation motor 120, a centrifugal force is formed around the outer periphery of the impeller 110, and the airflow in the impeller 110 flows in the direction of the centrifugal force. At this time, the airflow spreads out from the outer periphery of the impeller 110, thereby changing the flow direction of the airflow; and a negative pressure is formed at and near the rotation axis of the impeller 110, which can increase the airflow sucked into the first air inlet 102. Therefore, by designing the circulation power in a wind supply method in which the circulation motor 120 controls the rotation of the impeller 110 to form the negative pressure, the related losses caused by the direct collision of strong wind with other components are effectively avoided. Traditional fans usually cause high fosses when the airflow changes its flow direction, while the circulation module proposed in the embodiment of the present application provides power for the airflow to change its flow direction, thereby bringing more flexibility in the layout of the circulation module. In the embodiment of the present application, the circulation fan may include the circulation motor 120 and the impeller 110 which is driven to rotate by the circulation motor 120.

In some embodiments, the drying module further includes a pre-condenser, which is arranged on the circulation passage and is located upstream of the circulation module 10. The pre-condenser is used to pre-dehumidify the wet circulation airflow from the drum. In order lo make the rotary disk 200 have a better moisture adsorption effect, the pre-condenser is arranged upstream. of the circulation module 10 to reduce the humidity of the wet circulation airflow from the drum.

In some examples, the pre-condenser is a second condenser.

In some embodiments, the pre-condenser includes a water-cooling condenser or an air condenser, and the pre-condenser is arranged on the air outlet channel communicated with the drum air outlet. The air outlet channel communicated with the drum air outlet may be arranged at the left rear of the drum or the right rear of the drum. For example, when the pre-condenser is a water-cooling condenser, the pre-condenser may be arranged upstream of the filter assembly in the airflow direction, so that on the one hand, the humidity of the airflow entering the dehumidification module 20 can be reduced, and on the other hand, a portion of the fluff contained in the airflow can be directly taken away by condensate water, thereby reducing the cleaning frequency of the filter assembly. The water-cooling condenser arranged on the drum air outlet channel may specifically be a spray nozzle arranged at the water inlet for slowly spraying cooling water to the outer wall of the pipe to maintain the continuous low temperature of the pipe wall, so as to achieve condensation and dehydration of the wet circulation airflow flowing through the pipe. The drum air outlet channel may be configured with a double-layer pipe wall, and the double-layer pipe wall may include an inner ring pipe and an outer ring pipe arranged coaxially and spaced apart. The wet circulation airflow passes through the inner ring pipe, and a water-flowing space is formed between the inner ring pipe and the outer ring pipe to guide the cooling water to flow into the outer cylinder of the drum or the drain pipe of the washer. When the pre-condenser is an air condenser, the wet circulation airflow from the drum exchanges heat with the air condenser and is cooled down, and the water vapor in the wet circulation airflow is cooled to form condensate water to be discharged via the drain port of the air condenser.

In some embodiments, the drying module further includes: an auxiliary heater, which is arranged on the circulation passage and is located downstream of the dehumidification module 20. The auxiliary heater is used to heat the dry circulation airflow. The moisture of the wet circulation airflow from the drum is adsorbed by the rotary disk 200, so that the wet circulation airflow can be transformed into a dry circulation airflow. The auxiliary heater heats the dry circulation airflow to increase the temperature of the dry circulation airflow entering the drum, so as to speed up the drying of the clothes in the drum.

In some examples, the auxiliary heater is a second heater.

In some embodiments, the first partition component 221 is provided in the first rotary disk accommodating area to partition the first rotary disk accommodating area into a dehumidification area and a regeneration area, and the side wall of the rotary disk lower shell 220 is provided with the second air inlet 223 which is communicated with the first air outlet 103 and the dehumidification area of the second airflow channel respectively. Specifically, a gap is formed between the bottom surface of the rotary disk 200 and the bottom wall of the dehumidification area of the rotary disk lower shell to form the second airflow channel, and when the rotary disk 200 is working, the portion of the rotary disk 200 located in the dehumidification area can adsorb moisture in the wet circulation airflow entering the second airflow channel. During rotation of the rotary disk 200, when its portion that has adsorbed moisture in the dehumidification area rotates to the regeneration area, dehydration regeneration is performed.

In some embodiments, the second air outlet is provided on the side wall of the rotary disk upper shell 210, and the second air outlet is respectively communicated with the dehumidification area of the first airflow channel and the drum air inlet. The second air inlet 223 is located near one of the first partition body and the second partition body, and the second air outlet is located near the other one of the first partition body and the second partition body. The second air inlet 223 and the second air outlet are respectively arranged on two sides of the first partition body and the second partition body, and the wet circulation airflow from the drum enters the second airflow channel from the second air inlet 223, diffuses in the second airflow channel by the guidance of the dehumidification area, passes through the rotary disk 200 from bottom to top to reach the first airflow channel, and converges at the second air outlet on the other side of the dehumidification area, which relatively extends the flow path of the circulation airflow, so that the contact area between the circulation airflow and the bottom and top surfaces of the rotary disk 200 is larger, thereby improving the utilization rate of the rotary disk 200.

In some embodiments, the drying module further includes: the air outlet channel 203, which is located at the second air outlet, wherein the air outlet channel 203 protrudes from the outer side of the side wall of the rotary disk upper shell 210; the inlet duct 52, one end of which is communicated with the air outlet channel, and the other end of which is communicated with the drum air inlet; and the auxiliary heater, which includes a heating tube or a heating wire and is arranged in the inlet duct. A sealing ring may be provided between the inlet duct 52 and the air outlet channel 203, and a pair of matching connection flanges are provided at the ends of the inlet duct 52 and the air outlet channel 203, so that the inlet duct 52 and the air outlet channel 203 are connected and fixed by bolt connection, with the sealing ring therebetween being compressed and deformed to achieve a sealing effect. The auxiliary heater may include a heating tube or a heating wire, the heating tube or the heating wire is arranged along the inner wall of the inlet duct 52, and a thermal insulation material may be arranged between the heating tube or the heating wire and the inner wall of the inlet duct 52.

The circulation process of the wet circulation airflow from the drum will be explained in detail below in conjunction with the attached drawings.

Referring to FIG. 11, the circulation module 10 and the dehumidification module 20 together constitute a circulation passage. The flow direction of the wet circulation airflow from the drum is shown by the arrows in FIG. 11 as follows: the wet circulation airflow passes through the air outlet channel, which is provided with a filter screen and a pre-condenser, from the drum via the drum air outlet, the wet circulation airflow enters the corrugated hose 50 after pre-dehumidification (arrow 1), passes through the first air inlet 102, and reaches the lower side of the rotary disk 200 powered by the circulation fan (arrow 2), that is, diffuses in the second airflow channel, passes through the rotary disk 200 from the lower side of the rotary disk 200 to reach its upper side (arrow 3), the wet circulation airflow is adsorbed by the rotary disk 200 with moisture therein, and can be transformed into a dry circulation airflow that flows in the space above the rotary disk 200 (arrow 4), that is, reaches the inlet duct 52, which is provided with an auxiliary heater to heat the dry circulation airflow, through the first airflow channel (arrow 5), and the heated dry circulation airflow then passes through the inlet duct 52 and circulates into the drum (arrow 6).

In some embodiments, the drying module includes: a dehumidification module 20 including a second circulation passage that is communicated with the drum air outlet so that the wet circulation airflow in the drum flows into the second circulation passage, wherein the dehumidification module includes a rotary disk member, at least a portion of the rotary disk member is arranged on the second circulation passage, and the rotary disk member is used to adsorb moisture in the wet circulation airflow from the drum; and a circulation module 10, which is positioned downstream of the dehumidification module 20, and provided with a first circulation passage that is communicated with the drum air inlet so that the wet circulation airflow in the drum passes through the second circulation passage and the first circulation passage in sequence, and is transformed into a dry circulation airflow that enters the drum for the next cycle, wherein the drum, air outlet, the second circulation passage, the first circulation passage and the drum air inlet are communicated in sequence to form a circulation passage.

It can be understood that the circulation module 10 and the dehumidification module 20 in the above embodiments may be exchanged in position. In other words, the wet circulation airflow in the drum first passes through the drum air outlet channel into the dehumidification module 20, and then passes through the circulation module 10 into the drum through the drum air inlet channel. Thus, the connection relationship between the air inlet and the air outlet of each component may be adaptively adjusted.

The embodiment of the present application provides a circulation module 10, as shown in FIGS. 8-10, which may specifically include: a circulation module shell, an impeller 110 and a circulation motor 120. The circulation module shell is provided with a first air inlet 102 and a first air outlet 103; the impeller 110, which is arranged in the circulation module shell, wherein the rotation axis of the impeller 110 is parallel to the axis of the first air inlet 102, and the rotation axis of the impeller 110 is approximately perpendicular to the axis of the first air outlet 103; and the circulation motor 120, which is connected and fixed to the circulation module shell, wherein the output shaft of the circulation motor 120 is connected and fixed to the impeller 110. The rotation axis of the impeller 110 corresponds to the first air inlet, that is, the rotation axis of the impeller 110 may pass through the first air inlet 102 so that the impeller 110 may drive the airflow at the first air inlet 102 directly, whereby the airflow flows into the circulation module shell, and the airflow can be quickly drawn into the circulation module shell without increasing the rotation speed of the impeller 110. When the impeller 110 is driven to rotate by the circulation motor 120, a centrifugal force is formed around the outer periphery of the impeller 110, and the airflow in the impeller 110 flow's in the direction of the centrifugal force. At this time, the airflow spreads around the impeller 110, thereby changing the flow direction of the airflow. Moreover, negative pressure is formed at and near the rotation axis of the impeller 110, which can increase the airflow sucked into the first air inlet 102. Therefore, by designing the circulation power as a wind supply method in which the circulation motor 120 controls the rotation of the impeller 110 to form a negative pressure, the related damage caused by the direct collision of strong wind with other components can be effectively avoided. Traditional fans usually cause higher losses when the airflow changes its flow direction, whereas the circulation module provided in the embodiment of the present application provides power for the airflow to change its flow direction, so that more flexibility is enabled when the circulation module is laid out.

In an optional embodiment, the circulation module shell includes: a circulation module lower shell 112, which is provided with a recessed first impeller accommodating area; and a circulation module upper shell 111, which is provided with a recessed second impeller accommodating area. The circulation module lower shell 112 is connected with the circulation module upper shell 111 in a matching manner so that the first impeller accommodating area and the second impeller accommodating area form an impeller accommodating cavity. The impeller 110 is located in the impeller accommodating cavity, the impeller accommodating cavity may be set to a circle greater than the outer diameter of the impeller 110, and the axis of the impeller accommodating cavity is parallel to the rotation axis of the impeller 110. In this way, the airflow output by the rotation of the impeller 110 can be guided out through the inner side walls of the circulation module lower shell 112 and the circulation module upper shell 111.

In an optional embodiment, the circulation module lower shell 112 includes a first bottom plate 1122 and a first side wall 1121, in which the first side wall protrudes from the first bottom plate and is arranged along the circumferential direction of the first bottom plate 1122 to form the first impeller accommodating area. A first groove is arranged at the top of the first side wall 1121, and a scaling gasket 113 is arranged in the first groove. The circulation module upper shell 111 includes a first top plate 1112 and a second side wall 1111. The second side wall protrudes from the first top plate and is arranged along the circumferential direction of the first top plate 1112 to form the second impeller accommodating area. A first protrusion is arranged at the top of the second side wall 1111, and the first protrusion cooperates with the first groove. When the circulation module lower shell 112 and the circulation module upper shell 111 are connected, the first protrusion presses against the sealing gasket 113. The circulation module lower shell 112 may be prepared by bending the bottom plate upwards, and similarly, the circulation module upper shell 111 may be prepared by bending the top plate downwards. When the circulation module lower shell 112 and the circulation module upper shell 111 are assembled, the first protrusion squeezes the sealing gasket 113 in the first groove to deform the sealing gasket 113, so as to achieve an excellent sealing effect between the circulation module lower shell 112 and the circulation module upper shell 111.

In an optional embodiment, the impeller 110 includes: an impeller body 1101 and a fixed ring 1103 axially arranged opposite to the impeller body 1101, in which the impeller body 1101 extends in the direction of the fixed ring 1103 and is provided with an accommodating cavity for accommodating a circulation motor, one end of the circulation motor 120 is arranged in the accommodating cavity, and the output shaft of the circulation motor 120 is connected and fixed lo the bottom of the impeller body 1101; and blades 1102, the two ends of which are respectively fixedly connected to the impeller body 1101 and the fixed ring 1103, wherein the blades 1102 are arranged at intervals around the impeller body 1101, and the blades 1102 are arranged to be tilted forward along the rotation direction of the impeller. The impeller body 1101 may include a cover plate at the top, and one end of the blade 1102 in the length direction is fixedly connected to the cover plate, so that the airflow sucked from the bottom of the impeller can be blocked by the cover plate and output radially from the impeller. The impeller body 1101 extends in the direction of the blade 1102, and a recessed accommodating cavity is provided in the impeller body 1101. One end of the circulation motor 120 is embedded in the accommodating cavity, so that the overall axial length of the circulation fan is reduced and the overall length of the circulation fan is reduced. The blade 1102 is arranged to be tilted forward along the rotation direction of the impeller, which con improve the air outlet efficiency of the impeller and is conducive to improving the noise reduction effect of the fan and improving the energy efficiency of the fan.

In an optional embodiment, a through installation hole 1114 and positioning bumps are provided on the top of the first top plate 1112, and the installation hole 1114 is adapted to the circulation motor. The positioning bumps are arranged at intervals along the circumferential direction of the installation hole 1114, and the positioning bumps are inserted into the mounting bearing supports of the circulation motor, so that the circulation motor is fixed on the first top plate 1112. The mounting bearing support may be arranged on the shell of the circulation motor, and the mounting bearing support is arranged at the end of the shell of the circulation motor away from the output shaft. The mounting bearing support may be provided with a positioning hole adapted to the positioning bump, and the positioning hole may be set to be non-through. The mounting bearing support is provided with a bolt hole, and the bolt hole is communicated with the positioning hole. The positioning bump may be provided with a threaded hole, and the threaded hole is coaxially arranged and adapted with the bolt hole. The positioning bump is inserted into the positioning hole, and the bolt passes through the bolt hole and is screwed into the threaded hole, so that the circulation motor is fixed on the first top plate 1112 and the circulation motor is embedded in the installation hole 1114 and extends downward. In this way, the installation part of the circulation motor is located outside the circulation module upper shell 111, which is convenient for the installation and disassembly of the circulation motor.

In an optional embodiment, the circulation module shell is in the shape of a volute. The circulation module shell is provided with a contraction part, which extends in a direction perpendicular to the rotation axis of the impeller 110. The first air outlet is communicated with the impeller accommodating cavity through the contraction part. The circulation module shell is in the shape of a volute with a unique shape. After passing through the impeller 110, the airflow changes its flow direction and is output from the contraction part, which can prevent the airflow from circulating within the impeller accommodating cavity all the time, meet the fluid design requirements, and provide the maximum air volume and wind speed for the airflow.

In an exemplary embodiment, the first air in let 102 is located on the first bottom plate 1122, and the first air inlet 102 is coaxially arranged with the installation hole 1114. The contraction part has an air outlet cavity, the first air inlet 102, the impeller accommodating cavity, the air outlet cavity and the first air outlet are communicated in sequence, and the impeller accommodating cavity, the air outlet cavity and the first air outlet are located on the same horizontal plane. The contraction part has an air outlet cavity. The airflow changes its flow-direction after passing through the impeller 110 and flows to the first air outlet through the air outlet cavity. The air outlet cavity is roughly perpendicular to the rotation axis of the impeller 110, and the impeller accommodating cavity, the air outlet cavity and the first air outlet are roughly located on the same horizontal plane. In this way, the height dimension of the circulation module shell is reduced, the space occupied by the circulation module as a whole is reduced, and the height and volume of the washer-dryer machine using the circulation module are also reduced as a whole.

In an optional embodiment, the circulation module 10 further includes a circulation air interface member, which is connected to the contraction part. Alternatively, the circulation air interface member is integrated with the circulation module shell. The side of the circulation air interface member away from the contraction part is set to an are shape, and the circulation air interface member gradually expands toward the side away from the contraction part. The circulation air interface member is provided with an expansion air duct therein, and the two ends of the expansion air duct are respectively communicated with the air outlet cavity and the first air outlet. The circulation air interface member may be set as two separate upper and lower shells, which are connected to the circulation module upper shell 111 and the circulation module lower shell 112 respectively. The cross-sectional area of the expansion air duct gradually increases toward the side away from the contraction part, and when the airflow enters the air outlet cavity and the expansion air duct after passing through the impeller 110, the dynamic pressure energy of the airflow is further converted into static pressure energy, thereby enhancing the conversion capacity of dynamic pressure energy and improving the working performance of the fan.

In an optional embodiment, lower shell connection components 1123 are provided on the first side wall 1121. The lower shell connection components 1123 are arranged along the outer periphery of the first side wall 1121 and protrude from the first side wall 1121. Upper shell connection components 1113 are provided on the second side wall 1111, and the setting positions of the upper shell connection components 1113 correspond to those of the lower shell connection components 1123 one by one. The upper shell connection components 1113 are connected to the lower shell connection components 1123, so that the positions of the circulation module lower shell 112 and the circulation module upper shell 111 are relatively fixed. The upper shell connection components 1113 and the lower shell connection components 1123 may be provided with matching bolt through holes, and bolts may be inserted into the bolt through holes to achieve a detachable connection between the circulation module lower shell 112 and the circulation module upper shell 111.

In an optional embodiment, a fixing clip 1115 is provided on the circulation module shell, and is used to fix the line or pipeline, so that the wires of the circulation motor, or lines and pipelines such as the water and gas pipelines on the whole machine can be arranged better.

In an optional embodiment, the circulation module further includes a transitional component 130, which is provided on the circulation module lower shell 112 and adapted to the first impeller accommodating area. The transitional component is connected and fixed to the first bottom plate 1122. The transitional component is provided with a through hole, and the through hole is communicated with the first impeller accommodating area. The side of the transitional component away from the first impeller accommodating area is connected to the corrugated hose 50, and the corrugated hose 50 is interfaced to the air inlet of the lower shell through the transitional component 130. The transitional component may be provided with a first transition hole and a second transition hole, and both the first transition hole and the second transition hole are evenly distributed at intervals in the circumferential direction of the through hole. The diameter of the first air inlet 102 is smaller than the distribution diameter of the first transition hole. The end of the corrugated hose 50 may be provided with a corresponding threaded hole, and the bolt passes through the first transition hole and is screwed into the threaded hole to fix the corrugated hose 50 on the transitional component 130. The distribution diameter of the second transition hole is greater than the diameter of the first air inlet 102, the first bottom plate 1122 is provided with a threaded hole corresponding to the second transition hole, and the bolt passes through the second transition hole and is screwed into the threaded hole to fix the transitional component 130 on the first bottom plate 1122. A positioning sleeve may be provided on one side of the transitional component, and the positioning sleeve may be inserted into the corrugated hose 50. When installing the corrugated hose 50, the corrugated hose 50 may be first fixed to the transitional component 130, and then the transitional component 130 may be fixed to the first bottom plate 1122, so as to facilitate the installation and removal of the corrugated hose 50.

In some embodiments, as shown in FIG. 1, and FIGS. 12 to 17, the drying module includes a circulation module 10, a dehumidification module 20 and a regeneration module 30. The circulation module 10 is provided with a first circulation passage, which is communicated with the drum air outlet so that the wet circulation airflow in the drum enters the first circulation passage. The dehumidification module is provided with a second circulation passage, and the dehumidification module is located downstream or upstream of the circulation module. The drum air outlet, the first circulation passage, the second circulation passage and the drum air inlet are communicated in sequence to form a circulation passage. The dehumidification module includes a moisture adsorption and removal member, at least part of which is arranged on the second circulation passage, wherein the moisture adsorption and removal member is used to adsorb moisture in the wet circulation airflow from the drum. The regeneration module 30 includes a regeneration member, which is arranged adjacent to at least another part of the moisture adsorption and removal member and is used to at least partially discharge the moisture adsorbed on the at least another part of the moisture adsorption and removal member. The circulation module 10 may include a circulation fan. The setting of the circulation fan can supply power for the wet circulation airflow, which is conducive to the circulation of the airflow. The air inlet of the circulation fan is communicated with the drum air outlet, and the air outlet of the circulation fan is communicated with the second circulation passage. The moisture adsorption and removal member is arranged on the second circulation passage. The moisture adsorption and removal member may first adsorb the moisture in the wet circulation airflow from the drum, so that the wet circulation airflow becomes a relatively dry circulation airflow. The dry circulation airflow enters the drum through the drum air inlet and fully contacts with the clothes, thereby improving the drying efficiency and reducing energy consumption. To allow the continuous and repeated use of the moisture adsorption and removal member, the moisture adsorbed on the moisture adsorption and removal member is discharged by a regeneration member. The regeneration member may be, for example, a heating member or an ultrasonic member, etc., and the moisture adsorbed on the moisture adsorption and removal member may be removed by heating or ultrasonic dehumidification.

It can be understood that in one embodiment, close proximity may be a close setting, or a certain gap or distance may be maintained between the elements, as long as the regeneration member can be ensured to be located upstream of the moisture adsorption and removal member, as is apparent to those skilled in the art.

In some embodiments, the dehumidification module is located upstream of the circulation module, the second circulation passage is communicated with the drum air outlet, and the moisture adsorption and removal member may first adsorb the moisture in the wet circulation airflow from the drum. The first circulation passage is communicated with the drum air inlet, so that the relatively dry circulation airflow in the first circulation passage enters the drum. The drum air outlet, the second circulation passage, the first circulation passage and the drum air inlet are communicated in sequence to form a circulation passage.

In some embodiments, the moisture adsorption and removal member includes a rotary disk 200. The regeneration member is a heating member. The regeneration module is provided with a regeneration passage, and the heating member and at least a portion of the rotary disk are sequentially arranged on the regeneration passage so that the regeneration airflow in the regeneration passage flows through the heating member and at least part of the rotary disk in sequence to become a humid and hot regeneration airflow. Specifically, the moisture adsorption and removal member may include a rotary disk 200 and a drive assembly. The drive assembly may include a motor, and the motor may drive the rotary disk 200 to rotate. The rotary disk 200 may be made of a material with good moisture adsorption performance, such as zeolite, lithium chloride, silica gel, modified silica gel or 13X (sodium X type) molecular sieve. The heating member is arranged on the regeneration passage. For example, the heating member may include a heater, so that the regeneration airflow in the regeneration passage becomes a high-temperature regeneration airflow after being heated by the heater. In order to dehydrate the rotary disk more efficiently, the high-temperature regeneration airflow may pass through the part of the rotary disk 200 located in the regeneration passage, so that when the rotary disk 200 is rotated to the regeneration passage during rotation, the adsorbed moisture is continuously desorbed to keep the rotary disk 200 to be used continuously and repeatedly.

In some embodiments, the drying module may further include a rotary disk upper shell 210 and a rotary disk lower shell 220, which are connected in a matching manner to form a rotary disk accommodating cavity. The rotary disk 200 is installed in the rotary disk accommodating cavity, and there is a gap between the top surface of the rotary disk 200 and a part of the inner wall of the rotary disk upper shell to form a first airflow channel. There is a gap between the bottom surface of the rotary disk 200 and a part of the inner wall of the lower shell to form a second airflow channel. The second airflow channel is communicated with the drum air outlet, and the first airflow channel is communicated with the drum air inlet. The wet circulation airflow in the drum passes through the second airflow channel and passes through the rotary disk 200 from bottom to top to reach the first airflow channel to form a dry circulation airflow. Among them, the second airflow channel, the rotary disk 200 and the first airflow channel may form a second circulation passage.

In some embodiments, the regeneration passage is relatively isolated from the circulation passage so that the regeneration airflow and the wet circulation airflow are not connected to each other. Since a portion of the rotary disk 200 is located in the regeneration passage and the other portion is located in the circulation passage, the rotary disk 200 continuously passes through the regeneration passage and the circulation passage during its continuous rotation. In an exemplary embodiment, when a portion of the rotary disk 200 rotates into the regeneration passage, the high-temperature regeneration airflow may pass through the rotary disk 200 from top to bottom to achieve efficient dehydration of the rotary disk. When the other portion of the rotary disk 200 rotates into the circulation passage, the wet circulation airflow may pass through the rotary disk 200 from bottom to top, and the rotary disk 200 may fully adsorb the moisture in the wet circulation airflow. The regeneration airflow and the wet circulation airflow act on the rotary disk 200 at the same time. In order to maintain the smooth rotation of the rotary disk 200, the flow directions of the regeneration airflow and the wet circulation airflow may be set to be opposite. By arranging partitions and seals on the rotary disk upper shell 210 and the rotary disk lower shell 220, the rotary disk 200 can achieve a dynamic scaling effect during rotation, thereby minimizing the intercommunication between the wet circulation airflow and the regeneration airflow. This is beneficial for the rotary disk 200 to continuously adsorb moisture, dehydrate and dry during rotation, so that the rotary disk 200 maintains always a good water adsorption capacity, thereby improving the efficiency and effect of moisture adsorption.

In some embodiments, the regeneration module further includes a regeneration fan 301. which is arranged on the regeneration passage. The regeneration fan 301 is located upstream of the heating member. The arrangement of the regeneration fan 301 may supply power for the regeneration airflow, which is conducive to the circulation of the airflow and improves the efficiency.

In some embodiments, the drying module further includes a condensation module 40, which may specifically include a condenser 401. The condenser 401 is arranged on the regeneration passage between the rotary disk 200 and the regeneration fan 301. The condenser is located downstream of the rotary disk 200, and the condenser is located upstream of the regeneration fan 301, so that the hot and humid regeneration airflow in the regeneration passage enters the condenser 401, becomes a dry and cold regeneration airflow and flows into the regeneration fan 301, and thus the regeneration airflow forms a closed loop. When the rotary disk 200 is rotated to the regeneration passage, the regeneration airflow heats the part of the rotary disk 200, so that the moisture in this part evaporates quickly and is taken away by the regeneration airflow. At this time, the regeneration airflow becomes a humid and hot regeneration airflow and enters the condenser 401. Thus, the rotary disk 200 maintains always a good water adsorption capacity, further improving the efficiency and effect of the moisture adsorption of the rotary disk 200. In an exemplary embodiment, the humid and hot regeneration airflow enters the condenser 401 for heat exchange and cooling, the water vapor in the regeneration airflow is cooled to form condensed water which is then discharged from the condenser 401, and the dry low-temperature regeneration airflow enters the regeneration fan 301 for the next cycle. In an optional embodiment, the humid and hot regeneration airflow enters the condenser 401 for heat exchange and cooling. the water vapor in the regeneration airflow is cooled to form condensed water which is then discharged from the condenser 401, and the dry low-temperature regeneration airflow may be discharged into the atmosphere through the air outlet of the condenser 401 to avoid adverse effects on the atmospheric temperature and humidity of the space where the washer-dryer machine is located. Therefore, the regeneration airflow may form an open cycle.

In some embodiments, the regeneration module further includes a regeneration module upper shell 310, and the regeneration module upper shell 310 is provided with a heating member accommodating cavity. The heating member is mounted in the heating member accommodating cavity, the heating member is located upstream of the rotary disk, and the-heating member accommodating cavity is communicated with the rotary disk. The heating member is used to heat the regeneration airflow to at least partially evaporate the moisture adsorbed by the rotary disk 200. Specifically, the regeneration module upper shell 310 may include a top wall and a side wall protruding around the top wall to form a heating member accommodating cavity, and a base protruding outward along the side wall, and the base may be provided with an installation hole, through which it may be connected and fixed to the rotary disk upper shell 210.

In some embodiments, in order to make the incoming regeneration airflow more uniformly heated and the rotary disk 200 more uniformly dehydrated and dried, the preferred solution is that the heating member includes an air distribution member and a heater that are stacked, and the heater is located between the air distribution member and the rotary disk 200. The regeneration airflow enters the heating member accommodating cavity and passes through the air distribution member, the heater and the rotary disk 200 in sequence.

In some embodiments, the regeneration module upper shell 310 is a fan-shaped structure. The outer are side of the regeneration module upper shell 310 is provided with a heater air inlet 311. There is a gap between the air distribution member and the top wall of the regeneration module upper shell 310 to form a third airflow channel. There is a gap between the bottom surface of the rotary disk 200 and the inner wall of the regeneration area of the rotary disk lower shell 220 lo form a fourth airflow channel. The third airflow channel is communicated with the heater air inlet 311, so that the regeneration airflow enters the third airflow channel through the heater air inlet, passes through the air distribution member, the heater and the rotary disk from top to bottom to reach the fourth airflow channel, and becomes a humid and hot regeneration airflow. The regeneration airflow enters the third airflow channel through the heater air inlet 311, and the air distribution member may make the regeneration airflow contact with the heater more evenly. The evenly heated regeneration airflow dehydrates and dries a part of the rotary disk 200 in the regeneration area.

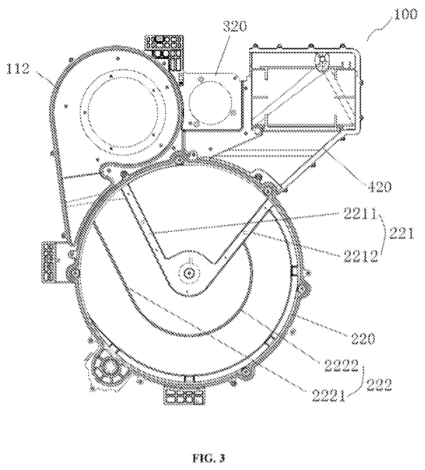

The condensation module 40 may specifically further include a condensation module upper shell 410 and a condensation module lower shell 420. The condensation module upper shell 410 and the condensation module lower shell 420 are connected in a matching manner to form a condenser accommodating cavity, and the condenser 401 is mounted in the condenser accommodating cavity. The arrow shown in FIG. 4 is the flow direction of the regeneration airflow. The regeneration airflow passes through the rotary disk from top to bottom to reach the fourth airflow channel, then becomes a humid and hot regeneration airflow which then flows into the condensation module lower shell 420 and enters the condenser 401 for heat exchange and cooling.

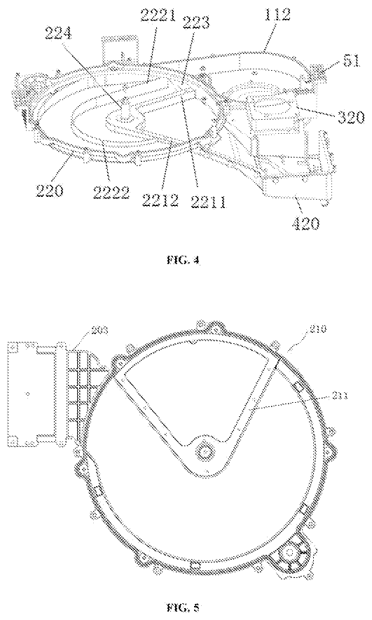

In some embodiments, the drying module further includes: a first connecting member 3013, whose two ends are respectively communicated with the condenser and the regeneration fan, so that the regeneration airflow enters the regeneration fan 301 via the condenser 401; and a second connecting member 3014, whose two ends are respectively communicated with the regeneration fan and the air inlet of the heater, so that the regeneration airflow enters the third airflow channel via the regeneration fan. Since the condenser 401 is very close to the regeneration fan 301, a hard pipe joint as shown in FIGS. 5-6 may be used, which can not only support the regeneration fan 301, but also make the overall structure of the drying module compact and occupy a small space. Of course, the first connecting member 3013 can also be a flexible member, which can be conveniently connected to the two hard structures of the condenser and the inlet of the regeneration fan.

In some embodiments, the regeneration module may further include a regeneration fan installation part 320, which may specifically include a regeneration fan upper shell 321 and a regeneration fan lower shell 322, wherein the regeneration fan upper shell 321 and the regeneration fan lower shell 322 constitute a regeneration fan accommodating cavity. The regeneration fan lower shell 322 is connected and fixed to the first connecting member 3013 by flange, which can firmly support the regeneration fan 301. The regeneration fan lower shell 322 may also be connected by a flexible first connecting member 3013, and one end of the first connecting member 3013 may be placed in the opening of the regeneration fan lower shell 322 of the by deformation. Because first connecting member 3013 is flexible, it can also help to form a good seal.

In some embodiments, the first connecting member 3013 includes a first air inlet and a first air outlet, the first air inlet is adapted to and communicated with the condenser air outlet, and the first air outlet is adapted to and communicated with the inlet of the regeneration fan. The first air inlet is a roughly rectangular opening, the first air outlet is a roughly circular opening, and the plane where the first air inlet is located is roughly perpendicular to the plane where the first air outlet is located to adjust the flow direction of the regeneration airflow. An end face of the first air inlet of the first connecting member 3013 is provided with a rectangular connecting flange or a flexible boundary so that it is deformed and placed into the condenser air outlet, and is connected and fixed to the condensation module upper shell 410 and the condensation module lower shell 420. The shell structure of the first connecting member 3013 is special-shaped, and the air duct in the first connecting member 3013 gradually transitions from a rectangular cross-section at the first air inlet to a circular cross-section at the first air outlet, ensuring that the first connecting member 3013 can guide the air smoothly.

In some embodiments, the second connecting member 3014 includes a second air inlet and a second air outlet, the second air inlet is adapted and communicated with the outlet of the regeneration fan, and the second air outlet is adapted and communicated with the heater air inlet. The second air inlet is a roughly rectangular opening, the second air outlet is an are-shaped opening, the plane where the second air inlet is located is roughly parallel to the plane where the second air outlet is located, and the area of the second air outlet is greater than that of the second air inlet. The air duct in the second connecting member 3014 gradually expands from the second air inlet to the second air outlet, thereby further converting the dynamic pressure energy of the airflow into static pressure energy, improving the conversion capacity of dynamic pressure energy, improving the working performance of the fan, and avoiding turbulence as much as possible.

In some embodiments, the regeneration member is an ultrasonic member. The ultrasonic member may include an ultrasonic generator, which generates ultrasonic energy during operation to enable the rotary disk 200 to vibrate at a high frequency, continuously destroying the water film and air film on the outer surface of the rotary disk 200, so as to enhance the heat and mass exchange coefficient between the rotary disk 200 and the regeneration airflow. The moisture adsorbed by the rotary disk 200 is taken away by the regeneration airflow through heat and mass exchange, thereby improving the regeneration efficiency of the rotary disk 200 at a lower temperature.

In some embodiments, the drying module further includes a rotary disk upper shell 210, on which a roughly fan-shaped regeneration module accommodating part is formed. The regeneration module 30 is mounted in the regeneration module accommodating part, and the regeneration module 30 is located above the rotary disk 200. The regeneration module is used, for example, to heal the regeneration airflow to desorb the moisture adsorbed by the rotary disk 200. The inner side of the regeneration module has an airflow space to form a third airflow channel. A gap is provided between the bottom surface of a portion of the rotary disk 200 and the inner wall of the regeneration area of the rotary disk lower shell 220 to form a fourth airflow channel. The regeneration module may include a heater for henting the regeneration airflow, and the heated regeneration airflow passes through the rotary disk 200 from top to bottom via the third airflow channel to reach the fourth airflow channel, and dehydrates the part of rotary disk 200 in the regeneration area. During the rotation of the rotary disk 200, it passes through the dehumidification area and the regeneration area, which is a continuous cycle of adsorbing and desorbing moisture.

In an exemplary embodiment, the rotary disk lower shell 220 may be provided with a first rotary disk accommodating area, and the rotary disk lower shell 220 may include a bottom plate and a circumferential side wall protruding from the bottom plate, and the recessed portion formed is the first rotary disk accommodating area. Similarly, the rotary disk upper shell 210 may be provided with a second rotary disk accommodating area, and the second rotary disk accommodating area includes at least a dehumidification area, but does not include a regeneration area. A regeneration module accommodating part is provided at the radial edge of the second rotary disk accommodating area. The second rotary disk accommodating area and a part of the first rotary disk accommodating area at least jointly form a dehumidification area, and the regeneration module accommodating part and another part of the first rotary disk accommodating area jointly form a regeneration area. Since there is airflow passing through the rotary disk accommodating cavity, the rotary disk upper shell 210 and the rotary disk lower shell 220 may be disposed to be connected in a sealed manner. For example, a groove or a flange is respectively provided on the rotary disk upper shell 210 or the rotary disk lower shell 220, and a scaling strip is provided in the groove, When the rotary disk upper shell 210 and the rotary disk lower shell 220 are buckled and connected, the flange supports the sealing strip in the groove to achieve sealing.

In some embodiments, the drying module further includes a rotary disk lower shell 220. The rotary disk lower shell 220 is provided with a first rotary disk accommodating area, and a first partition component 221 is provided in the first rotary disk accommodating area to divide the first rotary disk accommodating area into a dehumidification area and a regeneration area. The air outlet of the circulation fan is communicated to the dehumidification area. There is a gap between the bottom surface of the rotary disk 200 and the bottom wall of the dehumidification area of the rotary disk lower shell, which may form a second airflow channel. When the rotary disk 200 is working, the part of the rotary disk 200 located in the dehumidification area may adsorb moisture in the wet circulation airflow entering the second airflow channel. During the rotation of the rotary disk 200, the part that has adsorbed moisture in the dehumidification area is rotated to the regeneration area to undergo dehydration and regeneration.

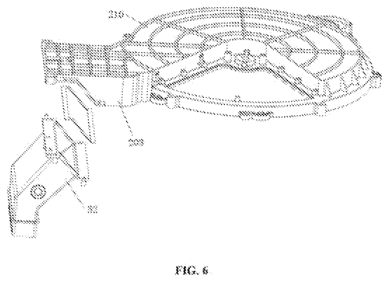

The embodiment of the present application provides a regeneration module 30, as shown in FIGS. 7-9, including: a regeneration module upper shell 310 having a heating member accommodating cavity; and a henting member, which is mounted in the heating member accommodating cavity, wherein the heating member is located above the rotary disk, the heating member accommodating cavity is communicated with the rotary disk, and the heating member is used to heat the regeneration airflow to desorb the moisture adsorbed by the rotary disk. In some embodiments, the rotary disk member may include a rotary disk 200 and a drive assembly, and the drive assembly may include a motor. The motor may drive the rotary disk 200 to rotate. The rotary disk 200 can be made of a material with good hygroscopic properties, such as zeolite, lithium chloride, silica gel, modified silica gel or 13X (sodium X type) molecular sieve. The wet circulation airflow discharged from the drum enters the bottom of the rotary disk accommodating cavity. The wet circulation airflow in the dehumidification area passes through the rotary disk 200 from bottom to top. The rotary disk 200 adsorbs the moisture in the wet circulation airflow, so that the wet circulation airflow can be transformed into a dry circulation airflow. The dry circulation airflow enters the drum through the drum air inlet and fully contacts the clothes, thereby improving the drying efficiency and reducing energy consumption. The regeneration member may include a heater for heating the regeneration airflow. The heated regeneration airflow passes through the heating member accommodating cavity and passes through the rotary disk 200 from top to bottom to dehydrate and dry the part of the rotary disk 200 in the regeneration area. During the rotation, the rotary disk 200 circulates through the dehumidification area and the regeneration area, which is a process of continuously adsorbing and desorbing moisture. In this way, the dry circulation airflow may be continuously obtained to enter the drum and fully contact the clothes, thereby improving the drying efficiency and reducing energy consumption.

Specifically, the regeneration module upper shelf 310 may include: a first top wall 312 and a third side wall 313 protruding around the first top wall 312 to form a heating member accommodating cavity, and a base 314 protruding outward along the third side wall 313, in which an installation hole may be provided on the base 314, through which the base 314 may be connected and fixed to the rotary disk upper shell 210.

In some embodiments, in order to make the incoming regeneration airflow more uniformly heated and the rotary disk 200 dehydrated and dried more uniformly, the preferred scheme is that the heating member includes an air distribution member and a heater that are stacked, the heater is located between the air distribution member and the rotary disk 200, and the regeneration airflow enters the heating member accommodating cavity and passes through the air distribution member, the heater and the rotary disk 200 in sequence. In some embodiments, the regeneration module upper shell 310 is a fan-shaped structure; the outer are side of the regeneration module upper shell 310 is provided with a heater air inlet 311. In the embodiment of the present application, the preferred solution is that the regeneration module upper shell 310 is a fan-shaped structure, or the regeneration module upper shell 310 may also be an irregular structure, which is not limited herein. The regeneration module upper shell 310 is connected with the rotary disk upper shell 210 in a matching manner so that the dehumidification area and the regeneration area are separated. In other words, the wet circulation airflow in the dehumidification area and the regeneration airflow in the regeneration area can be kept isolated to a large extent.

In some embodiments, there is a gap between the air distribution member and the top wall of the regeneration module upper shell 310 to form a third airflow channel, and the third airflow channel is communicated with the heater air inlet 311. There is a gap between the bottom surface of the rotary disk 200 and the inner wall of the regeneration area of the rotary disk lower shell 220 to form a fourth airflow channel. The regeneration airflow enters the third airflow channel through the heater air inlet 311, the air distribution member may make the regeneration airflow contact with the heater more evenly, and the uniformly healed regeneration airflow desorbs the moisture on the part of the rotary disk 200 in the regeneration area.

In some embodiments, the air distribution member includes an air distribution plate 330 and side plates protruding from the air distribution plate 330, The air distribution plate 330 and the side plates enclose a heater accommodating area, and the heater is arranged in the heater. accommodating area. The air distribution plate 330 is fan-shaped. The air distribution plate 330 is provided with vents 331 distributed at intervals. The arrangement of the vents allows the regeneration airflow to enter the heater below more evenly.

In some embodiments, the heater includes a plurality of heating tubes 340 connected end to end, and the heating tubes 340 are distributed at intervals along the radial direction of the fan. The length of the heating tube 340 is arranged approximately perpendicular to the radial direction of the fan. The heating tube 340 is distributed in an S-shaped manner, so that the length of the heating tube 340 in the heater accommodating area may be distributed longer to increase the contact area with the regeneration airflow, thereby achieving a higher efficiency of heat exchange with the regeneration airflow.

In some embodiments, the vents are arranged in rows, and the position of each row of vents roughly corresponds to the position of the heating tube 340. The diameter of the vent tends to decrease from the outer are to the center of the circle along the radius direction of the fan. The heater air inlet 311 is located on the outer are side of the regeneration module upper shell 310, the diameter of the vents is relatively greater near the heater air inlet 311, and the diameter of the vents away from the heater air inlet 311 is relatively smaller.

In some embodiments, the heating tube 340 is located below the vents. The axis of the heating lube 340 is offset from the center line of each row of corresponding vents, and the center line of each row of vents is closer to the heater air inlet 311 than the axis of the heating tube 340. The heating tube 340 is located below the vents, and the heating tube 340 is close to the air distribution plate 330, or adjacent to the air distribution plate 330, so as not to form a large resistance to the regeneration airflow passing through the vents. The heating tube 340 may be fixed on the air distribution plate 330 by a tube clamp, and a certain gap may be set between the heating tube 340 and the air distribution plate 330 to allow the regeneration airflow to pass through. When the regeneration airflow is blown in from the heater air inlet 311 and blows inward along the radius direction of the fan, there will be a speed along the flow direction of the regeneration airflow. Therefore, a slight offset is set for the center line of each row of vents, so that the regeneration airflow passing through the vents may face the heating tube 340 directly, so as to achieve a higher heat exchange efficiency between the regeneration airflow and the heating tube 340.

In some embodiments, the regeneration module upper shell 310 is a fan-shaped structure. The side wall of the regeneration module upper shell 310 is provided with a heater air inlet 311, and the side wall is arranged along the radial direction of the fan. The direction in which the regeneration airflow enters the heating member accommodating cavity is set opposite to the rotation direction of the rotary disk 200. That is, the regeneration airflow is blown into the heater accommodating space from the direction of the sector-shaped regeneration module approximately perpendicular to the radius along or against the rotation direction of the rotary disk, so that the airflow can be heated more evenly by the heater.

In some embodiments, the heater includes a plurality of heating tubes 340 connected end to end, and the heating tubes 340 are distributed at intervals along the radial direction of the fan. The length of the heating tube 340 is arranged parallel to the side wall opposite to the heater air inlet 311. Of course, the heating tube 340 can also be arranged approximately along the radial direction of the heating film group, and the air inlet direction perpendicular to the radial direction is adopted in this case, in order to achieve better uniform airflow and heating effect.

In some embodiments, the regeneration module further includes: a thermal conductive component 350, which is mounted in the second space, which is communicated with the heater accommodating area; and a temperature detection module, which is used to detect the temperature of the heater accommodating area. The temperature detection module is mounted in the third space, which is the space formed by covering with the thermal conductive component 350, and the third space is physically isolated from the second space by the thermal conductive component 350. The regeneration airflow is heated by the heater in the heater accommodating area and becomes a high-temperature regeneration airflow. Since the second space is communicated with the heater accommodating area, the high-temperature regeneration airflow diffuses in the second space. Therefore, the temperature in the heater accommodating area can be known by detecting the temperature of the second space. The temperature detection module is mounted in the third space, and the thermal conductive component 350 covers the temperature detection module. The thermal conductive component 350 transfers the heat received from the second space to the air in the third space. The temperature detection module detects the air temperature in the third space, and then measures the temperature of the regeneration airflow in the heater accommodating area communicated with the second space. The thermal conductive component 350 may be made of a metal material that is easy to conduct heat, such as copper or aluminum. The thermal conductive component 350 receives the heat of the high-temperature regeneration airflow in the second space and conducts it to the temperature detection module in the third space, which allows to evenly conduct heat and make the temperature detected by the temperature detection module tend to be stable, thereby improving the accuracy of the detection result. This can prevent the temperature. detection module from detecting the regeneration airflow in the heater accommodating area directly, because the regeneration airflow in the heater accommodating area may have turbulence or/turbulent flows, causing the detection result to jump frequently.

The base 314 extends away from the outer side of the heater accommodating area. The bottom surface of at least a part of the base 314 is provided with a groove, and the groove forms a second space. The thermal conductive component 350 is mounted in the groove, and the thermal conductive component 350 covers the temperature detection module. The base 314 includes a first side, the first side extends radially along the fan, and the groove is located on the first side. Of course, to detect more accurately, the same groove may be arranged on the second side opposite to the first side, and the temperature detection module is arranged therein. The groove is located on the first side, and is communicated with the heater accommodating area. The heated high-temperature regeneration airflow diffuses into the groove, and the thermal conductive component 350 is heated and conducted to the temperature detection module to prevent the temperature detection module from being directly blown by the regeneration airflow flowing in the heater accommodating area, thereby reducing the fluctuation of the detection result caused by turbulence/turbulent flows.

The regeneration module upper shell 310 is provided with a mounting seat 318, which is connected and fixed to the first side and located on the other side of the first side away from the groove. The mounting seat 318 is provided with a through installation hole, forming a roughly hexahedral shape with one side open, the temperature detection module is arranged inside the installation hole, and the space formed by the thermal conductive component 350 covering the open surface of the mounting seat 318 is the third space. The installation hole is adapted to the temperature detection module. Specifically, the temperature detection module is mounted in the installation hole and covered by the thermal conductive component 350, so that the temperature detection module is isolated from the second space to avoid leakage of the regeneration airflow. A fixing member may be provided on the mounting sent 318, and the fixing member may be used to fix a cable connected to the temperature detection module.

Further, the thermal conductive component 350 contacts the contact of the temperature detection module. The regeneration airflow flowing in the heater accommodating area may be turbulence/turbulent flows, and the temperature of the regeneration airflow is unstable in a local area. Alternatively, a ridge structure is provided on the side of the thermal conductive component 350 facing the second space to increase the contact area with the high-temperature regeneration airflow and extend the conduction path, so that the temperature conducted to the temperature detection module tends to a stable average. The thermal conductive component 350 may be provided as a heat conductive sheet, which is easy to shape to cover the temperature detection module. For example, a projection may be provided on the side of the thermal conductive component 350 facing the second space, and a recessed portion may be provided on the other corresponding side of the thermal conductive component 350. The temperature detection module may be embedded in the recessed portion, and the contact of the temperature detection module contacts the recessed portion, so that the contact area between the thermal conductive component 350 and the regeneration airflow is increased by the projection.

In some embodiments, the surface of the thermal conductive component 350 is provided with a heat-resistant and anti-corrosion coating to increase the service life of the thermal conductive component 350 and prevent the thermal conductive component 350 from rusting in a high temperature and humid environment.

The regeneration module provided in the embodiment of the present application is described in detail below in combination with the flow direction of the regeneration airflow.

As shown in FIGS. 1 to 7, the drying module includes a circulation module 10 and a dehumidification module 20. The circulation module 10 is provided with a first circulation passage, which is communicated with the drum air outlet so that the wet circulation airflow in the drum enters the first circulation passage. The dehumidification module 20 is located downstream of the circulation module 10, and the dehumidification module 20 is provided with a second circulation passage, which is communicated with the drum air inlet. The drum air outlet, the first circulation passage, the second circulation passage and the drum air inlet are communicated in sequence to form a circulation passage. The dehumidification module 20 includes a rotary disk member, at least part of which is arranged on the second circulation passage, and the rotary disk member is used to adsorb moisture in the wet circulation airflow from the drum. The wet circulation airflow in the drum passes through the first circulation passage and the second circulation passage in sequence, and is transformed into a dry circulation airflow. The circulation module 10 may include a circulation fan. The setting of the circulation fan may supply power for the wet circulation airflow, which is conducive to the circulation of the airflow. The air inlet of the circulation fan is connected to the drum air outlet, and the air outlet of the circulation fan is communicated with the second circulation passage. The rotary disk member is arranged on the second circulation passage. The rotary disk member may first adsorb the moisture in the wet circulation airflow from the drum, so that the wet circulation airflow becomes a relatively dry circulation airflow. The dry circulation airflow enters the drum via the drum air inlet and fully contacts with the clothes, thereby improving the drying efficiency and reducing energy consumption.

The second aspect of the present application provides a drying module, including: a dehumidification module having a second circulation passage, which is connected to the drum air outlet so that the wet circulation airflow in the drum enters the second circulation passage, wherein the dehumidification module includes a rotary disk member, at least part of the rotary disk member is arranged on the second circulation passage, and the rotary disk member is used to adsorb moisture in the wet circulation airflow from the drum; and a circulation module, which is located downstream of the dehumidification module, wherein the circulation module is provided with a first circulation passage, and the first circulation passage is communicated with the drum air inlet so that the wet circulation airflow in the drum passes through the second circulation passage and the first circulation passage in sequence, and becomes a dry circulation airflow that enters the drum for the next cycle. The drum air outlet, the second circulation passage; the first circulation passage and the drum air inlet are communicated in sequence to form a circulation passage.

It can be understood that the circulation module 10 and the dehumidification module 20 in the above embodiment may be swapped. That is, the wet circulation airflow in the drum first passes through the drum air outlet channel into the dehumidification module 20, and then passes through the circulation module 10 into the drum through the drum air inlet channel. Therefore, the connection relationship between the air inlets and the air outlets of various components may be adaptively adjusted.

The third aspect of the present application provides a washer-dryer machine, including the drying module.

The washer-dryer machine further includes a drum, which is provided with a drum air inlet and a drum air outlet. The drum air inlet and the drum air outlet may be respectively arranged at the two ends of a rotating shaft of the drum, so that the dry high-temperature airflow entering the drum may fully exchange heat with the clothes in the drum. The drum air inlet is located at the front or rear, and the drum air outlet is located at the rear or front. The drum air inlet and the drum air outlet are respectively communicated with the space between the outer drum and the inner drum of the drum. For example, the drum air inlet and the drum air outlet are respectively located at the two ends of the rotating shaft of the drum, so that the airflow can fully contact the clothes in the drum, thereby improving the drying efficiency.

Of course, the specific positions of the drum air inlet and the air outlet are not specifically limited in this disclosure, and they may also be located at the same end of the drum at the same time, or arranged on the drum in a staggered manner.

In some embodiments, the drying module may specifically include: a shell, which is provided with a rotary disk member accommodating cavity; and a rotary disk member, which is mounted in the rotary disk member accommodating cavity. The rotary disk member includes a rotary disk 200, at least part of which is used to adsorb moisture in the wet circulation airflow. There are gaps between the two sides of the rotary disk 200 and the first inner wall and the second inner wall of the shell, respectively, to form an airflow channel. The first inner wall and the second inner wall are arranged opposite to each other, and the first inner wall or the second inner wall and the two sides of the rotary disk 200 are substantially parallel. The drying module further includes at least one diversion component 222, which is at least arranged around one of the first inner wall or the second inner wall. The diversion component 222 is used to divert the airflow flowing into the airflow channel. In some embodiments, the rotary disk member may include a rotary disk 200 and a driving assembly, the driving assembly may include a motor, and the motor may drive the rotary disk 200 to rotate. The rotary disk 200 may be made of a material with good hygroscope performance, such as zeolite, lithium chloride, silica gel, modified silica gel or 13X (sodium X type) molecular sieve. The wet circulation airflow flowing into the airflow channel on one side of the rotary disk 200 passes through the rotary disk 200 to reach the airflow channel on the other-side. The rotary disk 200 adsorbs moisture in the wet circulation airflow so that the wet circulation airflow can be transformed into a dry circulation airflow. Since the connection between the air outlet of the circulation fan and the rotary disk member accommodating cavity is roughly along the tangential direction of the rotary disk, the circulation airflow has a certain flow velocity, and the wet circulation airflow has a high moisture content, the airflow will escape away from the rotation center of the rotary disk under the centrifugal force. The airflow is usually formed at the greater diameter of the rotary disk 200, and the airflow is small in the area close to the rotation center of the rotary disk, so that the main moisture adsorption part of the, rotary disk 200 is at the greater diameter, affecting the moisture adsorption efficiency and the moisture adsorption utilization rate of the rotary disk. To this end, a diversion component 222 is arranged around the bottom wall of the shell, which can divert the wet circulation airflow flowing into the airflow channel into one part entering the area close to the center of the circle and the other part entering the area close to the periphery of the rotary disk 200, whereby the wet circulation airflow flowing into the airflow channel is more dispersed and more uniform, and the airflow can contact the rotary disk 200 with a larger area, thereby improving the moisture adsorption efficiency of the rotary disk 200.

In some embodiments, the shell includes: a rotary disk lower shell 220, which is provided with a first rotary disk accommodating area; and a rotary disk upper shell 210, which is provided with a second rotary disk accommodating area. The rotary disk upper shell is cooperatively connected with the rotary disk lower shell so that the first rotary disk accommodating area and the second rotary disk accommodating area constitute the rotary disk member accommodating cavity. There is a gap between the top surface of the rotary disk 200 and a part of the inner top wall of the rotary disk upper shell 210 to form a first airflow channel. There is a gap between the bottom surface of the rotary disk 200 and a part of the bottom wall of the rotary disk lower shell to form a second airflow channel. The second airflow channel is communicated with the drum air outlet, and the first airflow channel is communicated with the drum air inlet, so that the wet circulation airflow in the drum passes through the second airflow channel and passes through the rotary disk 200 to reach the first airflow channel. By way of example, the diversion component 222 is arranged around the bottom wall of the rotary disk lower shell 220 to divert the airflow flowing into the second airflow channel. For example, the wet circulation airflow discharged from the drum enters the bottom of the rotary disk member accommodating cavity, that is, diffuses in the second airflow channel. When the diversion component 222 surrounds the inner bottom wall of the rotary disk lower shell, the incoming wet circulation airflow can be diverted first, with one part entering the area near the center of the circle and the other part entering the area near the outer periphery of the rotary disk 200, so that the wet circulation airflow flowing into the airflow channel is more dispersed and more uniform. The wet circulation airflow then passes through the rotary disk 200 from bottom to top, and the rotary disk 200 adsorbs moisture in the wet circulation airflow to cause the wet circulation airflow to be transformed into a dry circulation airflow, which can improve the moisture adsorption efficiency of the rotary disk 200. The dry circulation airflow flows from the first airflow channel to the drum air inlet into the drum, and fully contacts the clothes, thereby improving the drying efficiency and reducing energy consumption.

In some embodiments, the at least one diversion component 222 is disposed in the dehumidification area of the first rotary disk accommodating area to divide the dehumidification area into at least a first diversion area and a second diversion area. A second air inlet 223 is disposed on the side wall of the rotary disk lower shell 220, and one end of the diversion component 222 abuts against the second air inlet 223 to divide the second air inlet 223 into at least a first sub-port and a second sub-port, The first sub-port is communicated with the first diversion area, the second sub-port is communicated with the second diversion area, and so on. The diversion component 222 divides the second air inlet 223 into a first sub-port and a second sub-port. In this way, the wet circulation airflow is diverted at the second air inlet 223 by the diversion component 222 and enters two diversion areas near the center and the periphery, namely, the first diversion area and the second diversion area, so that the wet circulation airflow is reasonably diverted. Therefore, the wet circulation airflow flowing into the first airflow channel is more dispersed and more uniform, and the airflow can contact the rotary disk 200 with a larger area, which can improve the moisture adsorption efficiency of the rotary disk 200. It is understandable that for the dehumidification area of the first rotary disk accommodating area, more than two diversion components 222 may be provided, and may be arranged in parallel, so as to divide the dehumidification area into multiple diversion areas.

The embodiment of the present application provides a circulation module 10, as shown in FIGS. 8-10, which may specifically include: a circulation module shell, an impeller 110 and a circulation motor 120. The circulation module shell is provided with a first air inlet 102 and a first air outlet 103. The impeller 110 is arranged in the circulation module shell, the rotation axis of the impeller 110 is parallel to the axis of the first air inlet 102, and the rotation axis of the impeller 110 is approximately perpendicular to the axis of the first air outlet 103. The circulation motor 120 is connected and fixed to the circulation module shell, and the output shaft of the circulation motor 120 is connected and fixed to the impeller 110. The rotation axis of the impeller 110 corresponds to the first air inlet, that is, the rotation axis of the impeller 110 may pass through the first air inlet 102, so that the impeller 110 can directly drive the airflow at the first air inlet 102. Thus, the airflow flows into the circulation module shell, and the airflow can be quickly drawn into the circulation module shell without increasing the rotation speed of the impeller 110. When the impeller 110 is driven to rotate by the circulation motor 120, a centrifugal force is formed around the outer periphery of the impeller 110, and the airflow in the impeller 110 flows in the direction of the centrifugal force. At this time, the airflow spreads from the impeller 110, thereby changing the flow direction of the airflow, The negative pressure is formed at and near the rotation axis of the impeller 110, which can increase the airflow sucked into the first air inlet 102. Therefore, by designing the circulation power as a wind supply method in which the circulation motor 120 controls the rotation of the impeller 110 to form a negative pressure, the related damages caused by the direct collision of strong wind with other components can be effectively avoided. Conventional fans usually cause higher losses when the airflow changes its flow direction, whereas the circulation module provided in the embodiment of the present application provides power for the airflow to change its flow direction, so that more flexibility is enabled when the circulation module is laid out.

In an optional embodiment, the circulation module shell includes: a circulation module lower shell 112, which is provided with a recessed first impeller accommodating area; and a circulation module upper shell 111, which is provided with a recessed second impeller accommodating area. The circulation module lower shell 112 is connected with the circulation module upper shell 111 in a matching manner so that the first impeller accommodating area and the second impeller accommodating area constitute an impeller accommodating cavity. The impeller 110 is located in the impeller accommodating cavity, and the impeller accommodating cavity may be set to a circle with a diameter greater than the outer diameter of the impeller 110, and the axis of the impeller accommodating cavity is parallel to the rotation axis of the impeller 110, so that the airflow output by the rotation of the impeller 110 may be guided out through the inner sidewalls of the circulation module lower shell 112 and the circulation module upper shell 111.

In an optional embodiment, the circulation module lower shell 112 includes a first bottom plate 1122 and a first side wall 1121. The first side wall protrudes from the first bottom plate and is arranged along the circumferential direction of the first bottom plate 1122 to form the first impeller accommodating area. A first groove is arranged at the top of the first side wall 1121, and a sealing gasket 113 is arranged in the first groove. The circulation module upper shell 111 includes a first top plate 1112 and a second side wall 1111. The second side wall protrudes from the first top plate and is arranged along the circumferential direction of the first top plate 1112 to form the second impeller accommodating area. A first protrusion is arranged at the top of the second side wall 1111, and the first protrusion cooperates with the first groove. When the circulation module lower shell 112 and the circulation module upper shell 111 are connected, the first protrusion presses against the sealing gasket 113. The circulation module lower shell 112 may be prepared by bending the bottom plate upwards, and similarly, the circulation module upper shell 111 may be prepared by bending the top plate downwards. When the circulation module lower shell 112 and the circulation module upper shell 111 are assembled, the first protrusion squeezes the sealing gasket 113 in the first groove to deform the sealing gasket 113, so as to achieve an excellent scaling effect between the circulation module lower shell 112 and the circulation module upper shell 111.

In an optional embodiment, the impeller 110 includes: an impeller body 1101 and a fixed ring 1103 axially arranged opposite to the impeller body 1101, wherein the impeller body 1101 extends in the direction of the fixed ring 1103 and is provided with an accommodating cavity for accommodating a circulation motor, one end of the circulation motor 120 is arranged in the accommodating cavity, and the output shaft of the circulation motor 120 is connected and fixed to the bottom of the impeller body 1101; and blades 1102, the two ends of which are respectively fixedly connected to the impeller body 1101 and the fixed ring 1103, wherein the blades 1102 are arranged at intervals around the impeller body 1101, and the blades 1102 are arranged to be tilted forward along the rotation direction of the impeller. The impeller body 1101 may include a cover plate at the top, and one end of the blade 1102 along the length direction is fixedly connected to the cover plate, so that the airflow sucked from the bottom of the impeller can be blocked by the cover plate and output radially from the impeller. The impeller body 1101 extends in the direction of the blade 1102, and a recessed accommodating cavity is provided in the impeller body 1101. One end of the circulation motor 120 is embedded in the accommodating cavity, so that the overall axial length of the circulation fan is reduced, and the overall length of the circulation fan is reduced. The blade 1102 is arranged to be tilted forward along the rotation direction of the impeller, which can improve the air outlet efficiency of the impeller, and is conducive to improving the noise reduction effect of the fan and improving the energy efficiency of the fan.

In an optional embodiment, a through installation hole 1114 and positioning bumps are provided on the top of the first top plate 1112, and the installation hole 1114 is adapted to the circulation motor. The positioning bumps are arranged at intervals along the circumferential direction of the installation hole 1114, and the positioning bumps are inserted into the mounting bearing supports of the circulation motor, so that the circulation motor is fixed on the first top plate 1112. The mounting bearing support may be arranged on the shell of the circulation motor, and the mounting bearing support is arranged at one end of the shell of the circulation motor away from the output shaft. The mounting bearing support may be provided with a positioning hole adapted to the positioning bump, and the positioning hole may be set to be non-penetrating. The mounting bearing support is provided with a bolt hole, and the bolt hole is connected with the positioning hole. The positioning bump may be provided with a threaded hole, and the threaded hole is coaxially arranged and adapted with the bolt hole. The positioning bump is inserted into the positioning hole, and the bolt passes through the bolt hole and is screwed into the threaded hole, so that the circulation motor is fixed on the first top plate 1112 and the circulation motor is embedded in the installation hole 1114 and extends downward. In this way, the mounting part of the circulation motor is located outside the circulation module upper shell 111, which is convenient for the installation and removal of the circulation motor.

In an optional embodiment, the circulation module shell is a volute shape, the circulation module shell has a contraction part, and the contraction part extends in a direction perpendicular to the rotation axis of the impeller 110. The first air outlet is communicated with the impeller accommodating cavity through the contraction part. The circulation module shell is in the shape of a volute with a unique shape. After passing through the impeller 110, the airflow changes its flow direction and is output from the contraction part, which can prevent the airflow from circulating in the impeller accommodating cavity all the time, meet the fluid design requirements, and provide the maximum air volume and wind speed for the airflow.

In the exemplary embodiment, the first air inlet 102 is located on the first bottom plate 1122, and the first air inlet 102 is coaxially arranged with the installation hole 1114. The contraction part has an air outlet cavity, and the first air inlet 102, the impeller accommodating cavity, the air outlet cavity and the first air outlet are communicated in sequence. Moreover, the impeller accommodating cavity, the air outlet cavity and the first air outlet are located on the same horizontal plane. The contraction part has an air outlet cavity. The airflow changes its flow direction after passing through the impeller 110 and flows to the first air outlet through the air outlet cavity. The air outlet cavity is roughly perpendicular to the rotation axis of the impeller 110, and the impeller accommodating cavity, the air outlet cavity and the first air outlet are roughly located on the same horizontal plane, so that the height dimension of the circulation module shell is reduced, the space occupied by the circulation module as a whole is reduced, and the height and volume of the washer-dryer machine using the circulation module are also reduced as a whole.

In an optional embodiment, the circulation module 10 further includes a circulation air interface member, which is connected to the contraction part. Alternatively, the circulation air interface member is integrated with the circulation module shell. The side of the circulation air interface member away from the contraction part is set to an are shape, and the circulation air interface member gradually expands toward the side away from the contraction part. The circulation air interface member is provided with an expansion air duct therein, and the two ends of the expansion air duct are respectively communicated with the air outlet cavity and the first air outlet. The circulation air interface member may be set as two separate upper and lower shells, which are connected to the circulation module upper shell 111 and the circulation module lower shell 112 respectively. The cross-sectional area of the expansion air duct gradually increases toward the side away from the contraction part. When the airflow enters the air outlet cavity and the expansion air duct after passing through the impeller 110, the dynamic pressure energy of the airflow is further converted into static pressure energy, thereby improving the conversion capacity of dynamic pressure energy and improving the working performance of the fan.

In an optional embodiment, lower shell connection components 1123 are provided on the first side wall 1121, and the lower shell connection components 1123 are arranged at intervals along the outer periphery of the first side wall 1121 and protrude from the first side wall 1121. Upper shell connection components 1113 are provided on the second side wall 1111, the setting positions of the upper shell connection components 1113 correspond to those of the lower shell connection components 1123 one by one, and the upper shell connection components 1113 are connected to the lower shell connection components 1123, so that the positions of the circulation module lower shell 112 and the circulation module upper shell 111 are relatively fixed. The upper shell connection components 1113 and the lower shell connection components 1123 may be provided with matching bolt through holes, and bolts may be inserted into the bolt through holes to achieve a detachable connection between the circulation module lower shell 112 and the circulation module upper shell 111.

In an optional embodiment, a fixing clip 1115 is provided on the circulation module shell. The fixing clip 1115 is used to fix the line or pipeline, so that the wires of the circulation motor, or lines and pipelines such as the water and gas pipelines on the whole machine can be arranged better.

In an optional embodiment, the circulation module further includes a transitional component 130, which is provided on the circulation module lower shell 112 and is adapted to the first impeller accommodating area. The transitional component is connected and fixed to the first bottom plate 1122. The transitional component is provided with a through hole, and the through hole is communicated with the first impeller accommodating area. The side of the transitional component away from the first impeller accommodating area is connected to the corrugated hose 50, and the corrugated hose 50 is connected to the air inlet of the lower shell through the transitional component 130. The transitional component may be provided with a first transition hole and a second transition hole, and the first transition hole and the second transition hole are evenly distributed at intervals along the circumferential direction of the through hole. The diameter of the first air inlet 102 is smaller than the distribution diameter of the first transition hole. The end of the corrugated hose 50 may be provided with a corresponding threaded hole, and the bolt passes through the first transition hole and is screwed into the threaded hole to fix the corrugated hose 50 on the transitional component 130. The distribution diameter of the second transition hole is greater than the diameter of the first air inlet 102, and the first bottom plate 1122 is provided with a threaded hole corresponding to the second transition hole. The bolt passes through the second transition hole and is screwed into the threaded hole to fix the transitional component 130 on the first bottom plate 1122. A positioning sleeve may be provided on one side of the transitional component, and the positioning sleeve may be inserted into the corrugated hose 50. When mounting the corrugated hose 50, the corrugated hose 50 may be first fixed to the transitional component 130, and then the transitional component 130 may be fixed to the first bottom plate 1122, so as to facilitate the installation and removal of the corrugated hose 50.

The first aspect of the present application provides a drying module, as shown in FIGS. 1 to 7, including: a shell, which is provided with a rotary disk member accommodating cavity; and a rotary disk member, which is mounted in the rotary disk member accommodating cavity. The rotary disk member includes a rotary disk 200, at least part of which is used to adsorb moisture in the wet circulation airflow. There are gaps between the two sides of the rotary disk 200 and the first inner wall and the second inner wall of the shell, respectively, to form an airflow channel. The first inner wall and the second inner wall are arranged opposite to each other, and the first inner wall or the second inner wall is substantially parallel to the two sides of the rotary disk 200. The drying module further includes at least one diversion component 222, which is at least arranged around one of the first inner wall or the second inner wall and is used to divert the airflow flowing into the airflow channel. In some embodiments, the rotary disk member may include a rotary disk 200 and a driving assembly, the driving assembly may include a motor, and the motor may drive the rotary disk 200 to rotate. The rotary disk 200 may be made of a material with good hygroscopic performance, such as zeolite, lithium chloride, silica gel, modified silica gel or 13X (sodium X type) molecular sieve, etc. The wet circulation airflow flowing into the airflow channel on one side of the rotary disk 200 passes through the rotary disk 200 to reach the airflow channel on the other side. The rotary disk 200 adsorbs moisture in the wet circulation airflow, so that the wet circulation airflow can be transformed into a dry circulation airflow. Since the connection between the air outlet of the circulation fan and the rotary disk member accommodating cavity is roughly along the tangential direction of the rotary disk, the circulation airflow has a certain flow velocity, and the wet circulation airflow has a high moisture content, the airflow will escape away from the rotation center of the rotary disk under the centrifugal force. The airflow is usually formed at the greater diameter of the rotary disk 200, and the airflow is small in the area close to the rotation center of the rotary disk, so that the main moisture adsorption part of the rotary disk 200 is at the greater diameter, affecting the moisture adsorption efficiency and the moisture adsorption utilization rate of the rotary disk. To this end, a diversion component 222 is arranged around the bottom wall of the shell to divert the wet circulation airflow flowing into the airflow channel, with one part entering the area close to the center of the circle and the other part entering the area close to the outer periphery of the rotary disk 200. Thus, the wet circulation airflow flowing into the airflow channel is more dispersed and more uniform, and the airflow can contact the rotary disk 200 with a larger area, thereby improving the moisture adsorption efficiency of the rotary disk 200.

In some embodiments, the shell includes: a rotary disk lower shell 220, which is provided with a first rotary disk accommodating area; and a rotary disk upper shell 210, which is provided with a second rotary disk accommodating area, The rotary disk upper shell is cooperatively connected with the rotary disk lower shell so that the first rotary disk accommodating area and the second rotary disk accommodating area constitute the rotary disk member accommodating cavity. There is a gap between the top surface of the rotary disk 200 and a part of the inner top wall of the rotary disk upper shell 210 to form a first airflow channel. There is a gap between the bottom surface of the rotary disk 200 and a part of the bottom wall of the rotary disk lower shell to form a second airflow channel. The second airflow channel is communicated with the drum air outlet, and the first airflow channel is communicated with the drum air inlet, so that the wet circulation airflow in the drum passes through the second airflow channel and passes through the rotary disk 200 to reach the first airflow channel. By way of example, the diversion component 222 is arranged around the bottom wall of the rotary disk lower shell 220 to divert the airflows flowing into the second airflow channel. For example, the wet circulation airflow discharged from the drum flows into the bottom of the rotary disk member accommodating cavity, namely, diffuses in the second airflow channel. When the diversion component 222 surrounds the inner bottom wall of the rotary disk lower shell, the incoming wet circulation airflow may be diverted first, one part flowing into the area close to the center of the circle, and the other part flowing into the area close to the outer periphery of the rotary disk 200. Thus, the wet circulation airflow flowing into the airflow channel is more dispersed and more uniform. The wet circulation airflow then passes through the rotary disk 200 from bottom to top, and the rotary disk 200 adsorbs the moisture in the wet circulation airflow, so that the wet circulation airflow becomes a dry circulation airflow, which can improve the moisture adsorption efficiency of the rotary disk 200. The dry circulation airflow flows into the drum air inlet from the first airflow channel into the drum, and fully contacts with the clothes, so as to improve the drying efficiency and reduce energy consumption.

It can be understood that the present disclosure does not specifically limit the specific position of the air inlet of the rotary disk, as long as the airflow can enter from the rotary disk shell, pass through the rotary disk, and then flow out from the rotary disk shell. It can be seen that the airflow may also flow in from the first airflow space between the rotary disk and the upper shell, and then flow out from the second airflow space between the rotary disk and the lower shell after passing through the rotary disk. Moreover, the circulation fan may be located upstream of the rotary disk or downstream of the rotary disk, and may be designed and implemented according to actual situations. The diversion component 222 is set corresponding to the position of the rotary disk airflow inlet. For example, the diversion component 222 may be set on the inner wall of the lower shell, and of course it may also be set on the inner wall of the upper shell.

In some embodiments, a first partition component 221 is provided in the first rotary disk accommodating area to at least partition the first rotary disk accommodating area into a dehumidification area and a regeneration area. There is a gap between the bottom surface of the rotary disk 200 and the bottom wall of the dehumidification area of the rotary disk lower shell, to form a second airflow channel. A part of the rotary disk 200 is located above the dehumidification area, which may adsorb moisture in the wet circulation airflow entering the second airflow channel. During the rotation of the rotary disk 200, when the part of the rotary disk that has adsorbed moisture is rotated to the regeneration area, the moisture is desorbed, and then the part of the rotary disk that has desorbed moisture continues to rotate to the dehumidification area to adsorb moisture, and so on. In an exemplary embodiment, the rotary disk lower shell 220 may be provided with a first rotary disk accommodating area, the rotary disk lower shell 220 may include a bottom plate and a circumferential side wall protruding from the bottom plate, and the recessed portion formed is the first rotary disk accommodating area. Similarly, the rotary disk upper shell 210 may be provided with a second rotary disk accommodating area, and the second rotary disk accommodating area includes at least a dehumidification area, but does not include a regeneration area, and a regeneration module installation part is provided at the radial edge of the second rotary disk accommodating area. The second rotary disk accommodating area and part of the first rotary disk accommodating area at least jointly form a dehumidification area, and the regeneration module installation part and another part of the first rotary disk accommodating area jointly form a regeneration area. Since there is airflow passing through the rotary disk accommodating cavity, the rotary disk upper shell 210 and the rotary disk lower shell 220 may be connected in a sealed manner. For example, a groove or a flange is provided on the rotary disk upper shell 210 or the rotary disk lower shell 220, a scaling strip is provided in the groove, and the rotary disk upper shell 210 and the rotary disk lower shell 220 are buckled and connected to achieve sealing.

In some embodiments, the at least one diversion component 222 is disposed in the dehumidification area of the first rotary disk accommodating area to divide the dehumidification area into at least a first diversion area and a second diversion area. A second air inlet 223 is disposed on the side wall of the rotary disk lower shell 220. One end of the diversion component 222 abuts against the second air inlet 223 to divide the second air inlet 223 into at least a first sub-port and a second sub-port, the first sub-port is communicated with the first diversion area, the second sub-port is communicated with the second diversion area, and so on. The diversion component 222 divides the second air inlet 223 into a first sub-port and a second sub-port, so that the wet circulation airflow is diverted at the second air inlet 223 by the diversion component 222. and enters two diversion areas near the center and the periphery, namely, the first diversion area and the second diversion area. In this way, the wet circulation airflow is reasonably diverted to make the wet circulation airflow flowing into the first airflow channel more dispersed and more uniform, and the airflow can contact the rotary disk 200 with a larger area, which can improve the moisture adsorption efficiency of the rotary disk 200. It is understandable that more than two diversion components 222 may be provided for the dehumidification area of the first rotary disk accommodating area, and may be arranged in parallel, so as to divide the dehumidification area into multiple diversion areas.

In some embodiments, the first partition component 221 is arranged along the radial direction of the rotary disk lower shelf 220, and a rotary disk installation area is formed at the center of the first rotary disk accommodating area. The first partition component 221 arranged approximately radially makes the dehumidification area and the regeneration area both approximately fan-shaped. The area of the dehumidification area may be set to 2-3 times the area of the regeneration area. The area of the dehumidification area may be set to be greater than that of the regeneration area, so that most part of the rotary disk 200 is located in the dehumidification area, thereby further improving the moisture adsorption efficiency and moisture adsorption effect of the rotary disk 200. In order to prevent the wet circulation airflow discharged from the drum from intercommunicating with the regeneration airflow, a certain dynamic sealing effect may be formed between the first partition component 221 and the rotary disk 200. When the rotary disk 200 is rotated to the regeneration area, the regeneration airflow heats the rotary disk 200 of this port, so that the moisture in this part evaporates quickly and is carried away by the regeneration airflow into the condenser. Thus, the rotary disk 200 maintains always a good water adsorption capacity, thereby improving the efficiency and effect of moisture adsorption.

In some embodiments, the drying module further includes: an air outlet channel 203, which is located at the second air outlet and protrudes from the outside of the side wall of the rotary disk upper shell 210; an inlet duct 52, one end of which is communicated with the air outlet channel and the other end of which is communicated with the drum air inlet; and an auxiliary heater including a heating tube or a heating wire and arranged in the inlet duct. A sealing ring may be provided between the inlet duct 52 and the air outlet channel 203, and a pair of matching connecting flanges are provided at the ends of the inlet duct 52 and the air outlet channel 203. The inlet duct 52 and the air outlet channel 203 are connected and fixed by bolt connection, and the sealing ring in the middle is compressed and deformed to achieve a sealing effect. The auxiliary heater may include a heating tube or a heating wire, which is arranged along the inner wall of the inlet duct 52, and a heat insulating material may be arranged between the heating tube or the heating wire and the inner wall of the inlet duct 52.

In an optional-embodiment, lower shell connection components 1123 are arranged on the first side wall 1121, and the lower shell connection components 1123 are arranged at intervals along the outer periphery of the first side wall 1121 and protrudes from the first side wall 1121. Upper shell connection components 1113 are arranged on the second side wall 1111, and the arrangement positions of the upper shell connection components 1113 correspond to those of the lower shell connection components 1123 one by one. The upper shell connection components 1113 are connected to the lower shell connection components 1123, so that the positions of the circulation module lower shell 112 and the circulation module upper shell 111 are relatively fixed. Matching bolt through holes may be provided on the upper shell connection components 1113 and the lower shell connection components 1123, and bolts may be inserted into the bolt through holes to achieve a detachable connection between the circulation module lower shell 112 and the circulation module upper shell 111.

In an optional embodiment, a fixing clip 1115 is provided on the circulation module shell. and the fixing clip 1115 is used to fix the line or pipeline, so that the wires of the circulation motor, or lines and pipelines such as the water and gas pipelines on the whole machine can be arranged better.

In an optional embodiment, the circulation module further includes a transitional component 130, which is provided on the circulation module lower shell 112 and is adapted to the first impeller accommodating area. The transitional component is connected and fixed to the first bottom plate 1122. The transitional component is provided with a through hole, and the through hole is communicated with the first impeller accommodating area. The side of the transitional component away from the first impeller accommodating area is connected to the corrugated hose 50, and the corrugated hose 50 is connected to the air inlet of the lower shell through the transitional component 130. The transitional component may be provided with a first transition hole and a second transition hole, and both the first transition hole and the second transition hole are evenly distributed at intervals along the circumferential direction of the through hole. The diameter of the first air inlet 102 is smaller than the distribution diameter of the first transition hole. The end of the corrugated hose 50 may be provided with a corresponding threaded hole, and the bolt passes through the first transition hole and is screwed into the threaded hole to fix the corrugated hose 50 on the transitional component 130. The distribution diameter of the second transition hole is greater than the diameter of the first air inlet 102, the first bottom plate 1122 is provided with a threaded hole corresponding to the second transition hole, and the bolt passes through the second transition hole and is screwed into the threaded hole to fix the transitional component 130 on the first bottom plate 1122. A positioning sleeve may be provided on one side of the transitional component, and the positioning sleeve may be inserted into the corrugated hose 50. When mounting the corrugated hose 50, the corrugated hose 50 may be first fixed to the transitional component 130, and then the transitional component 130 may be fixed to the first bottom plate 1122, so as to facilitate the installation and removal of the corrugated hose 50.

As shown in FIG. 20, the drying module further includes a pipeline connection module. The pipeline connection module includes: a first connection component A, whose two ends are respectively communicated with the condensation module 40 and the regeneration fan 301, so that the regeneration airflow enters the regeneration fan 301 through the condensation module 40; and/or, a second connection component B, whose two ends are respectively communicated with the regeneration fan 301 and the heating module 302, so that the regeneration airflow enters the heating module 302 through the regeneration fan 301.

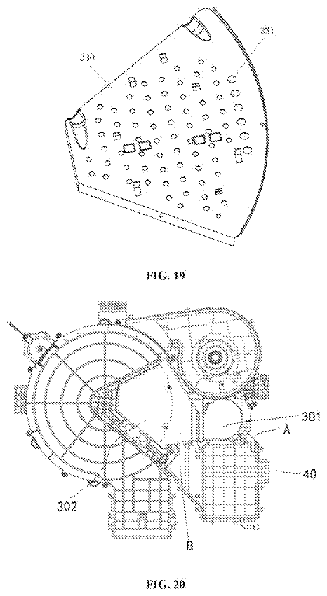

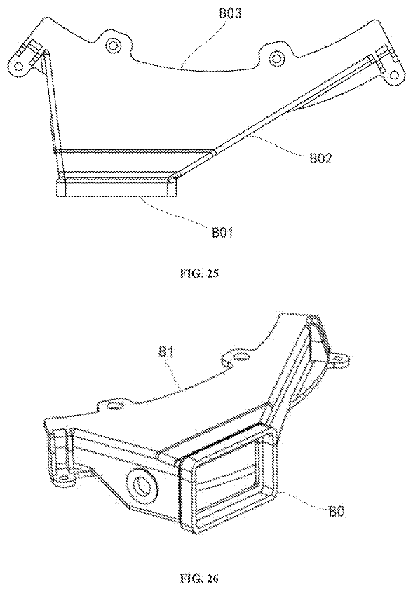

In some embodiments, as shown in FIG. 21, the first connection component A includes a first air inlet 102 and a first air outlet 103, the first air inlet 102 is communicated with the air outlet of the condensation module 40, and the first air outlet 103 is communicated with the air inlet of the regeneration fan 301; and/or, as shown in FIG. 26, the second connection component B includes a second air inlet B0 and a second air outlet B1, the second air inlet B0 is communicated with the air outlet of the regeneration fan 301, and the second air outlet B1 is communicated with the air inlet of the heating module 302.

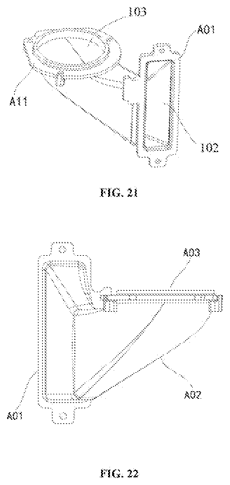

In some embodiments, as shown in FIGS. 21 to 22, the first connection component A includes a shell. Along the circumferential direction of the shell, the shell includes a first side surface A01, a second side surface A02 and a third side surface A03 connected in sequence. The first side surface A01 and the third side surface A03 are substantially perpendicular. The first side surface A01 is provided with the first air inlet 102, and the third side surface A03 is provided with the first air outlet 103.

As shown in FIGS. 21 to 24, in some embodiments, the first air inlet 102 is a substantially rectangular opening, the first air inlet 102 is adapted to the air outlet of the condensation module 40, and the first air inlet 102 is interfaced with the air outlet of the condensation module 40 in a sealing manner.

In some embodiments, as shown in FIGS. 21 to 22 again, the first air outlet 103 is a substantially circular opening, the first air outlet 103 is adapted to the air inlet of the regeneration fan 301, and the first air outlet 103 is interfaced or sleeved with the air inlet of the regeneration fan 301 in a scaling manner.

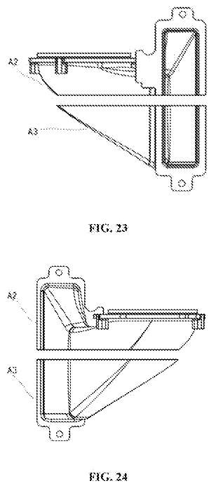

In some embodiments, as shown in FIGS. 23 to 24, the first connection component A is spliced from a first connection body A2 and a second connection body A3. The first connection body A2 is provided with the first air outlet 103, and the first air inlet 102 is spliced from the first connection body A2 and the second connection body A3. The first connection body A2 and the second connection body A3 are two parts separated approximately in the middle of the long side perpendicular to the first air inlet 102. The first connection component A is formed by welding the first connection body A2 and the second connection body A3, or by fastening them via sealing gasket bolts, and the first connection component A may be used to adjust the direction of the airflow, In some embodiments, since the temperature of the airflow flowing through the first connection component A is not high and it is assembled between the hard condensation module 40 and the regeneration fan 301, it may be integrally formed with a flexible part, and the appearance is generally shown in FIG. 21. A first side surface A01 and a second installation outer base A11 are respectively provided at the first air inlet 102 and the first air outlet 103, and a structure for clamping and fastening with the first side surface A01 and the second installation outer base A11 is provided at the air outlet of the condensation module 40 and the air inlet of the shell of the regeneration fan 301. During the installation, the first air inlet 102 and the first air outlet 103 of the flexible first connecting component A are deformed so as to extend into the shell of the condensation module 40 and the shell of the air inlet of the regeneration fan 301. At this time, the deformation of the flexible first connecting component A is restored, and the first side surface A01 and the second installation outer base A11 are clamped in the air outlet of the condensation module 40 shell and the air inlet shell of the regeneration fan 301, respectively. Then, the first side surface A01 and the second installation outer base A11 are clamped between a pressing plate or a hoop and the inner wall of the shell inside the condensation module 40 shell and the regeneration fan 301 shell by the pressing plate or the hoop, thereby realizing the sealing and fastening installation of the flexible first connecting component A.

In some embodiments, as shown in FIGS. 25 to 26, the second connection component B includes a shell. Along the circumferential direction of the shell, the shell includes a fourth side surface B01, a fifth side surface B02 and a sixth side surface B303 connected in sequence. The ends of the fifth side surface B02 are respectively connected to the fourth side surface B01 and the sixth side surface B03. The fourth side surface B01 is provided with a second air inlet B0, and the sixth side surface B03 is provided with a second air outlet B1.

In some embodiments, as shown in FIGS. 25 to 26, the second air inlet B0 is a roughly rectangular opening, the second air inlet BOO is adapted to the shape of the air outlet of the regeneration fan 301, and the second air inlet BO is scaled and connected to the air outlet of the regeneration fan 301.

In some embodiments, as shown in FIGS. 25 to 26, the second air outlet B1 is an arc-shaped opening, and the opening amplitude is gradually expanded along the short sides of the second air inlet B0 to the short sides of the second air outlet B1. The short side length of the second air outlet B1 is less than the short side length of the second air inlet B0. The second air outlet B1 is adapted to the air inlet of the heating module 302, and the second air outlet B1 is sealed and connected to the air inlet of the heating module 302.

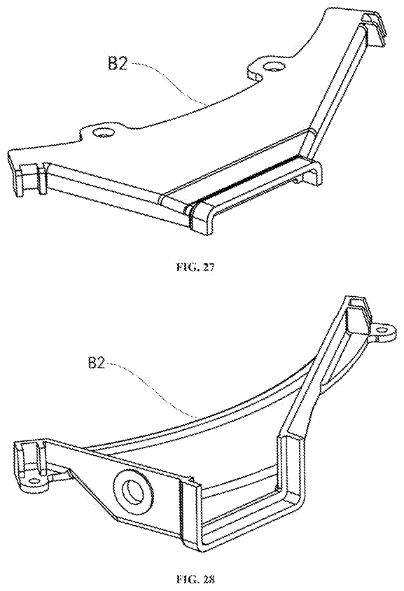

In some embodiments, as shown in FIGS. 27 to 29, the second connection component B is composed of a third connection body B2 and a fourth connection body B3, and the second air inlet B0 and the second air outlet B1 are spliced from the third connection body B2 and the fourth connection body B3. The third connection body B2 and the fourth connection body B3 are two parts cut in a direction perpendicular to the second air inlet B0 and the second air outlet B1, and the second connection component B is formed by welding the third connection body B2 and the fourth connection body B3, or by fastening them via sealing gasket bolts.

In some embodiments, as shown in FIGS. 21 and 26, since the first connection component A and the second connection component B are both special-shaped parts, it is difficult to manufacture them by one-step molding, and problems such as complex molds and difficulty in demolding may be encountered. In the embodiment of the present disclosure, one component is split into multiple parts for processing and manufacturing. In some embodiments, the welding method may include ultrasonic welding, friction welding and hot melt welding. With the above connection methods, the first connection body A2 and the second connection body A4, and the third connection body B2 and the fourth connection body are respectively welded into two complete connection components, and then the first connection component A or the second connection component B is mounted to the desired position. In some embodiments, as shown in FIGS. 30-32, the first connection component A is scaled by plane grooving. For example, a sink groove and a protrusion may be respectively provided on the first connection body A2 and the second connection body A4. The protrusion may extend into the sink groove, and a sealing gasket may also be placed in the sink groove first. The protrusion abuts the gasket in the sink groove to achieve better sealing.

In some embodiments, as shown in FIGS. 30-32, the second connection component B is sealed by a combination of plane groove sealing and annular plane/grooving. For example, a sink groove and a protrusion may be respectively provided on the third connection body B2 and the fourth connection body B4. The protrusion may extend into the sink groove, and a sealing gasket may be placed in the sink groove first. The protrusion abuts against the gasket in the sink groove to achieve better sealing.

In some embodiments, the first connection component A is a flexible integral part, a first side surface A01 is provided at the first air inlet A0; and a second installation outer base A11 is provided at the first air outlet A1. The first side surface A01 and the second installation outer base are sealed and connected to the air outlet of the condensation module 40 and the air inlet of the regeneration fan 301.

The embodiment of the present application provides a washer-dryer machine, including a drum and a drying module, and the drying module is provided with a regeneration circulation module in any of the above embodiments.

In some embodiments, the fust connection component A or the second connection component B is disassembled and parted by plane parting.

In some embodiments, the first connection component A or the second connection component B is fixed by a “two holes+two holes+two holes” method.

As shown in FIG. 20, in some embodiments, the disclosed embodiment further includes a washer-dryer machine. The washer-dryer machine includes a drum and a drying module. The drying module includes a moisture adsorption channel, a moisture removal channel, and a moisture adsorption and removal member. The moisture removal channel includes but is not limited to a fan, a regeneration mechanism (heater), and a condenser, wherein a connection component is connected between the fan and the regeneration mechanism, and between the fan and the condenser.

### Embodiment 1

The heater air inlet 311 is located on the outer are side of the regeneration module upper shell 310, and the regeneration module upper shell 310 is fan-shaped. The regeneration airflow enters the third airflow channel radially from the heater air inlet 311, enters the heater accommodating area through the vents on the air distribution plate 330, and performs heat exchange with the heating pipe 340. The high-temperature regeneration airflow after heating passes through the rotary disk 200 to dehydrate and dry the part of the rotary disk 200 in the regeneration area. The diameter of the vent tends to decrease from the outer are to the center of the circle along the radius of the fan. The heating tube 340 is distributed in an S shape. The heating tube 340 is spaced along the radius direction of the fan and the length of the heating tube 340 is set to be perpendicular to the radius direction of the fan. Since the vents on the air distribution plate 330 are arranged corresponding to the heating tube 340, the diameter of the vent is relatively large near the heater air inlet 311, and the diameter of the vent far from the heater air inlet 311 is relatively small. That is, the flow rate of the heated high-temperature regeneration airflow received by the rotary disk 200 in the regeneration area decreases uniformly or unevenly from the outer are to the center of the circle along the radius direction of the fan, so that the rotary disk 200 can be healed and dried more uniformly.

### Embodiment 2

The similarities between Embodiment 2 and Embodiment 1 are not repeated here. The differences between Embodiment 2 and Embodiment 1 are described as follows.

The heater air inlet 311 is located on the side wall of the regeneration module upper shell 310. The side wall is arranged in a radial direction of the fan shape. The flow direction of the regeneration airflow is opposite to or the same as the rotation direction of the rotary disk. The regeneration airflow enters the third airflow channel from the heater air inlet 311, enters the heater accommodating area through the vents on the air distribution plate 330, and exchanges heat with the heating tube 340. The heated high-temperature regeneration airflow passes through the rotary disk 200 from top to bottom, and dehydrates and dries the part of the rotary disk 200 in the regeneration area. The heating tube 340 is distributed in an S shape, the length of the heating tube 340 is parallel to the side wall opposite to the heater air inlet 311, and the heating tube 340 is distributed at intervals along the radial direction of the fan shape. Since the vents on the air distribution plate 330 are arranged corresponding to the heating tube 340, the vents on the air distribution plate 330 on the side away from the heater air inlet 311 are arranged relatively densely and the diameter of the vents is also greater. The flow rate of the high-temperature regeneration airflow after heating is controlled by the setting of the vents. When the rotary disk 200 adsorbs the moisture of the wet circulation airflow via the dehumidification area and is rotated to the regeneration area, the part of the rotary disk 200 is first dehydrated and dried with a large flow of high-temperature regeneration airflow, and then when rotating through the regeneration area, the flow rate of the high-temperature regeneration airflow is gradually reduced, so that the rotary disk 200 can be heated and dried more evenly.

The second aspect of the present application provides a washer-dryer machine, including a drying module as described in any of the above technical solutions.

The washer-dryer machine provided in the embodiment of the present application includes a drying module as described in any of the above technical solutions, so the washer-dryer machine can achieve all the beneficial effects of the drying module of the above technical solutions, which will not be described here.

In some embodiments, the washer-dryer machine further includes:
a drum, which is provided with a drum air inlet and a drum air outlet, in which the drum air inlet and the drum air outlet may be respectively arranged at both ends of a rotating shaft of the drum, so that the dry high-temperature airflow entering the drum can fully exchange heat with the clothes in the drum; and the drying module; wherein the second airflow channel is communicated with the drum air outlet, and the first airflow channel is communicated with the drum air inlet; the wet circulation airflow in the drum passes through the second airflow channel and passes through the rotary disk 200 from bottom to top to reach the first airflow channel to form a dry airflow; wherein the rotary disk 200 is used to adsorb moisture in the wet circulation airflow.

A washer-dryer machine includes a drum and a drying module, wherein the drum air inlet is located at the front or rear, and the drum air outlet is located at the rear or front; and the drum air inlet and the drum air outlet are respectively communicated with the space between the outer drum and the inner drum of the drum. For example, the drum air inlet and the drum air outlet are respectively located at opposite ends of the drum, so that the airflow can fully contact the clothes in the drum and improve the drying efficiency.

It is understandable that the drum may be a drum.

Of course, the specific positions of the drum air inlet and the drum air outlet are not specifically limited in this disclosure, and they may also be located at the same end of the drum at the same time, or staggered on the drum.

In this application, the terms “first”, “second”, and “third” are only used for descriptive purposes and cannot be understood as indicating or implying relative importance. The term “a plurality of” refers to two or more, unless otherwise clearly defined. Terms such as “installation”, “connected”, “connection”, and “fix” should be understood in a broad sense. For example, “connection” may be a fixed connection, a detachable connection, or an integral connection; “connected” may be a direct connection or an indirect connection through an intermediate medium. For ordinary technicians in this field, the specific meanings of the above terms in this application may be understood according to specific circumstances.

In the description of this application, it should be understood that the terms “upper”, “lower”, “left”, “right”, “front”, “back” and the like indicate the orientation or positional relationship based on the orientation or positional relationship shown in the drawings, which is only for the convenience of describing this application and simplifying the description, rather than indicating or implying that the device or unit referred to must be positioned in a specific direction, be constructed and operated in a specific orientation, and therefore, cannot be understood as a limitation on the present application.

In the description of this specification, the description of the terms “one embodiment”, “some embodiments”, “specific embodiments” and the like means that the specific features, structures, materials or characteristics described in conjunction with the embodiment or example are included in at least one embodiment or example of this application. In this specification, the schematic representation of the above terms does not necessarily refer to the same embodiment or example. Moreover, the specific features, structures, materials or characteristics described may be combined in any one or more embodiments or examples in a suitable manner.

The above are only preferred embodiments of this application and are not intended to limit this application. For those skilled in the art, this application may have various changes and variations. Any modifications, equivalent substitutions, improvements, etc. made within the spirit and principles of this application shall be included in the scope of protection of this application.

1. A drying module, comprising:
a circulator, communicated with an accommodating apparatus and configured to output a wet airflow from the accommodating apparatus to a dehumidifier;
the dehumidifier, communicated with the circulator and the accommodating apparatus, and configured to adsorb moisture of the wet airflow from the accommodating apparatus;
a regenerator, communicated with at least a portion of the dehumidifier, and configured to output a regeneration airflow to the dehumidifier, so as to desorb moisture adsorbed by the dehumidifier; and
a shell, provided with accommodating areas for respectively accommodating the circulator, the dehumidifier and the regenerator.

2. The drying module according to claim 1, further comprising:
a condenser, configured to condense the moisture desorbed from the dehumidifier, the shell being further provided with an accommodating area for the condenser, wherein the accommodating areas for the circulator, the dehumidifier and the condenser are integrally formed,
wherein the dehumidifier is connected and fixed to a frame, and the circulator and/or the condenser are connected and fixed to the accommodating apparatus.

3. The drying module according to claim 1, wherein the shell comprises:
a first shell and a second shell, which form an accommodating cavity by enclosing, wherein the shell is provided with an overlapping part for being installed on an electrical device.

4. The drying module according to claim 2, wherein
at least one group of the circulator, the dehumidifier and the regenerator is connected via a corrugated hose.

5-8. (canceled)

9. The drying module according to claim 1, wherein the dehumidifier further comprises: an air inlet channel installed on the accommodating apparatus, one end of which is communicated with the accommodating apparatus, and the other end of which is communicated with the circulator; and
a filter assembly is provided in the air inlet channel for filtering impurities in circulation airflows.

10. The drying module according to claim 1, wherein the regenerator comprises: a heating module, an inlet end of which is provided with a regeneration-fan installation part, wherein the heating module is configured to desorb the moisture adsorbed on the dehumidifier; and
a regeneration fan, installed on the regeneration-fan installation part, communicated with the condenser, and configured to transport a low-temperature dry regeneration airflow formed by condensation of the condenser to the heating module.

11. The drying module according to claim 1, wherein the circulator comprises:
a circulator shell, provided with a first air inlet and a first air outlet;
an impeller, arranged in the circulator shell, a rotation axis of the impeller being substantially parallel to an axis of the first air inlet and being substantially perpendicular to an axis of the first air outlet; and
a circulation motor, connected and fixed to the circulator shell, an output shaft of the circulation motor being connected and fixed to the impeller.

12. The drying module according to claim 11, wherein the circulator shell comprises:
circulator first shell, provided with a first impeller accommodating area which is recessed; and
a circulator second shell, provided with a second impeller accommodating area which is recessed, wherein the circulator first shell and the circulator second shell are connected in a matching manner so that the first impeller accommodating area and the second impeller accommodating area form an impeller accommodating cavity.

13-20. (canceled)

21. The drying module according to claim 3, wherein the first shell is provided with a first rotary disk accommodating area, the second shell forms a second rotary disk accommodating area, and the dehumidifier comprises:
a rotary disk second shell, connected with the first shell so that at least portions of the first rotary disk accommodating area and the second rotary disk accommodating area form a rotary disk accommodating cavity; and
a rotary disk member, installed in the rotary disk accommodating cavity and comprising a rotary disk for adsorb and desorb moisture in a wet circulation airflow, wherein a gap is formed between a top surface of the rotary disk and a portion of an inner wall of the rotary disk second shell to form a first airflow channel, and a gap is formed between a bottom surface of the rotary disk and a portion of an inner wall of the first shell to form a second airflow channel, wherein
the second airflow channel or the first airflow channel is communicated with an air outlet of the accommodating apparatus, and the first airflow channel or the second airflow channel is communicated with an air inlet of the accommodating apparatus, so that the wet circulation airflow in the accommodating apparatus passes through the second airflow channel or the first airflow channel and passes through the rotary disk to reach the first airflow channel or the second airflow channel.

22-31. (canceled)

32. The drying module according to claim 1, wherein
the circulator is provided with a first circulation passage, which is communicated with an air outlet of the accommodating apparatus or an air inlet of the accommodating apparatus so that a wet circulation airflow in the accommodating apparatus enters the first circulation passage or an airflow in the first circulation passage enters the accommodating apparatus;
the dehumidifier is located downstream or upstream of the circulator and is provided with a second circulation passage communicated with the air inlet of the accommodating apparatus or the air outlet of the accommodating apparatus; the air outlet of the accommodating apparatus, the first circulation passage, the second circulation passage and the air inlet of the accommodating apparatus are communicated to form a circulation passage; the dehumidifier comprises a moisture adsorption and removal member, at least a portion of which is arranged on the second circulation passage, and which is configured to adsorb moisture in the wet circulation airflow from the accommodating apparatus; and
the regenerator comprises a regeneration member which is arranged adjacent to at least another portion of the moisture adsorption and removal member and is configured to discharge at least a portion of moisture adsorbed on the at least another portion of the moisture adsorption and removal member.

33. The drying module according to claim 32, wherein
the moisture adsorption and removal member comprises a rotary disk;
the regeneration member is a heating member; and
the regeneration member is provided with a regeneration passage on which the heating member and at least a portion of the rotary disk are sequentially arranged, so that the regeneration airflow in the regeneration passage flows through the heating member and the at least a portion of the rotary disk sequentially.

34-41. (canceled)

42. The drying module according to claim 1, wherein
the circulator is provided with a first circulation passage, which is communicated with an air outlet of the accommodating apparatus or an air inlet of the accommodating apparatus so that a wet circulation airflow in the accommodating apparatus enters the first circulation passage or an airflow in the first circulation passage enters the accommodating apparatus;
the dehumidifier is located downstream or upstream of the circulator and is provided with a second circulation passage communicated with the air inlet of the accommodating apparatus or the air outlet of the accommodating apparatus; the dehumidifier comprises a rotary disk member, at least a portion of which is arranged on the second circulation passage, and which is configured to adsorb moisture in the wet circulation airflow from the accommodating apparatus; and
the air outlet of the accommodating apparatus, the first circulation passage or the second circulation passage, the second circulation passage or the first circulation passage, and the air inlet of the accommodating apparatus are communicated in sequence to form a circulation passage, wherein the wet circulation airflow in the accommodating apparatus passes through the first circulation passage and the second circulation passage and re-enters the accommodating apparatus.

43. The drying module according to claim 3, wherein the first shell is provided with a first rotary disk accommodating area; the second shell is provided with a second rotary disk accommodating area, a rotary disk second shell and a rotary disk first shell are connected in a matching manner, so that the first rotary disk accommodating area and the second rotary disk accommodating area form a rotary disk-member accommodating cavity in which a rotary disk member is installed;
the rotary disk member comprises a rotary disk;
a gap is formed between a top surface of the rotary disk and a portion of a top wall of the rotary disk second shell to form a first airflow channel; a gap is formed between a bottom surface of the rotary disk and a portion of a bottom wall of the rotary disk first shell to form a second airflow channel; and
the second airflow channel, the rotary disk and the first airflow channel form a second circulation passage, wherein the second airflow channel is communicated with a first circulation passage, and the first airflow channel is communicated with an air inlet of the accommodating apparatus, so that a wet circulation airflow in the accommodating apparatus passes through the second airflow channel and passes through the rotary disk to reach the first airflow channel.

44. The drying module according to claim 42, wherein the circulator comprises: a circulator shell, which is provided with an impeller accommodating cavity and is provided with a first air inlet and a first air outlet thereon;
an impeller, arranged in the impeller accommodating cavity, a rotation axis of the impeller being substantially parallel to an axis of the first air inlet and being substantially perpendicular to an axis of the first air outlet;
a circulation motor, connected and fixed to the circulator shell, an output shaft of the circulation motor being connected and fixed to the impeller; and
the first air inlet, the impeller accommodating cavity and the first air outlet form the first circulation passage, wherein the first air inlet is communicated with the air outlet of the accommodating apparatus, and the first air outlet is communicated with the second circulation passage, so that the wet circulation airflow in the accommodating apparatus enters the first circulation passage and the second circulation passage in sequence.

45-49. (canceled)

50. The drying module according to claim 1, wherein a rotary disk-member accommodating cavity is provided in the shell, and the dehumidifier comprises:
a rotary disk member, which is installed in the rotary disk-member accommodating cavity and comprises a rotary disk, at least a portion of the rotary disk being configured to adsorb moisture in a wet circulation airflow, wherein gaps are arranged between both side surfaces of the rotary disk and a first inner wall and a second inner wall of the shell to form airflow channels, wherein the first inner wall and the second inner wall are arranged opposite to each other, and the first inner wall or the second inner wall is substantially parallel to both the side surfaces of the rotary disk; and
at least one diversion component, arranged on at least one of the first inner wall or the second inner wall in an encircled manner, and configured to divert an airflow flowing into the airflow channel.

51. The drying module according to claim 50, wherein the shell comprises: a rotary disk first shell provided with a first rotary disk accommodating area; and
a rotary disk second shell, provided with a second rotary disk accommodating area and connected with the rotary disk first shell in a matching manner so that at least portions of the first rotary disk accommodating area and the second rotary disk accommodating area form the rotary disk-member accommodating cavity, wherein
a gap is formed between a top surface of the rotary disk and a portion of an inner top wall of the rotary disk second shell to form a first airflow channel; a gap is formed between a bottom surface of the rotary disk and a portion of a bottom wall of the rotary disk first shell to form a second airflow channel;
the second airflow channel is communicated with an air outlet of the accommodating apparatus or an air inlet of the accommodating apparatus, and the first airflow channel is communicated with the air inlet of the accommodating apparatus or the air outlet of the accommodating apparatus, so that a wet circulation airflow in the accommodating apparatus passes through the second airflow channel or the first airflow channel and passes through the rotary disk to reach the first airflow channel or the second airflow channel; and
the diversion component is arranged on the bottom wall of the rotary disk first shell or a bottom wall of the rotary disk second shell in an encircled manner, so as to divert an airflow flowing into the second airflow channel or the first airflow channel.

52-57. (canceled)

58. The drying module according to claim 1, further comprising: a pipeline connection module which comprises:
a first connection component, two ends of which are respectively communicated with a condenser and a regeneration fan, so that the regeneration airflow passes through the condenser and enters the regeneration fan; and/or a second connection component, two ends of which are respectively communicated with the regeneration fan and a heating module, so that the regeneration airflow passes through the regeneration fan and enters the heating module.

59. The drying module according to claim 58, wherein the first connection component comprises a first air inlet communicated with a condenser air outlet, and a first air outlet communicated with an inlet of the regeneration fan; and/or the second connection component comprises a second air inlet communicated with an outlet of the regeneration fan, and a second air outlet communicated with a heating-module air inlet.

60-63. (canceled)

64. A washer-dryer machine, comprising a drying module, according wherein the drying module comprises:
a circulator, communicated with an accommodating apparatus and configured to output a wet airflow from the accommodating apparatus to a dehumidifier;
the dehumidifier, communicated with the circulator and the accommodating apparatus, and configured to adsorb moisture of the wet airflow from the accommodating apparatus;
a regenerator, communicated with at least a portion of the dehumidifier, and configured to output a regeneration airflow to the dehumidifier, so as to desorb moisture adsorbed by the dehumidifier; and
a shell, provided with accommodating areas for respectively accommodating the circulator, the dehumidifier and the regenerator.

65. The washer-dryer machine according to claim 64, further comprising:
the accommodating apparatus, provided with an air inlet of the accommodating apparatus and an air outlet of the accommodating apparatus that are respectively arranged at two opposite ends of the accommodating apparatus,
wherein a second airflow channel or a first airflow channel is communicated with the air outlet of the accommodating apparatus, and the first airflow channel or the second airflow channel is communicated with the air inlet of the accommodating apparatus; and
a wet circulation airflow in the accommodating apparatus passes through the second airflow channel or the first airflow channel and passes through a rotary disk to reach the first airflow channel or the second airflow channel, so as to form a dry airflow, wherein the rotary disk is configured to adsorb moisture in the wet circulation airflow.
